(19) United States
(12) Patent Application Publication
(10) Pub. No.: US 2026/0340682 A1
(43) Pub. Date: Oct. 29, 2026

(54) Methods And Systems For Ad Replacement In An Over-The-Air Radio Broadcast Signal

(71) Applicant: iBiquity Digital Corporation, Columbia, MD (US)

(72) Inventors: Paul Peyla, Elkridge, MD (US); Jeffrey Baird, Columbia, MD (US); Michael Raide, Frederick, MD (US); William Snelling, Columbia, MD (US); Christopher Gould, Surbiton (GB); Kaushal Patel, North Brunswick, NJ (US)

(73) Assignee: iBiquity Digital Corporation, Columbia, MD (US)

(21) Appl. No.: 19/700,083

(22) Filed: Jun. 5, 2026

Related U.S. Application Data
(63) Continuation of application No. PCT/US2024/058673, filed on Dec. 5, 2024.
(60) Provisional application No. 63/606,095, filed on Dec. 5, 2023.

(51) Int. Cl. G06Q 30/0251; G10L 19/018

(52) U.S. Cl. CPC G06Q 30/0267; G10L 19/018

(57) ABSTRACT

Methods and systems for replacement of advertisements received over an over-the-air radio broadcast signal with IP-delivered targeted advertisements are provided. The methods include a method for processing an audio broadcast signal in a broadcast radio receiver, wherein an ad insertion start sample count that indicates the start of an original advertisement content is received at the broadcast radio receiver. After synchronization of the transmitted and the received audio streams, a targeted advertisement content which replaces at least some of the original advertisement content is inserted in the audio stream starting with the sample associated with the ad insertion start sample count. Replacing original advertisement content with targeted advertisement content ends with a sample of the audio stream associated with an ad insertion stop sample count.

### RELATED APPLICATION AND PRIORITY CLAIM

This application is related to and claims priority to U.S. Provisional Application No. 63/606,095, filed on Dec. 5, 2023, and entitled “AD INSERTION USING PERIODIC AUDIO WATERMARKING”, which is hereby incorporated by reference in its entirety.

### FIELD OF THE INVENTION

The described methods and systems generally relate to the replacement of advertisements received over an over-the-air radio broadcast signal by IP-delivered targeted advertisements. The methods and systems include methods and systems for processing an audio broadcast signal in a broadcast radio receiver, methods and systems for providing an audio broadcast signal in a radio broadcasting system, and methods and systems for synchronizing transmit and receive sample counts of an audio stream.

### BACKGROUND

Over-the-air radio broadcast signals are used to deliver a variety of programming content (e.g., audio, advertising, etc.) to radio receiver systems. Such over-the-air radio broadcast signals can include conventional AM (amplitude modulation) and FM (frequency modulation) analog broadcast signals, digital radio broadcast signals, or other broadcast signals. Digital radio broadcasting technology delivers digital audio and data services to mobile, portable, and fixed receivers. One type of digital radio broadcasting, referred to as in-band on-channel (IBOC) digital audio broadcasting (DAB), uses terrestrial transmitters in the existing Medium Frequency (MF) and Very High Frequency (VHF) radio bands. HD Radio™ by iBiquity Digital Corporation is based on IBOC digital radio broadcasting.

There is an interest in replacing ads received through a digital over-the-air radio broadcast signal such as HD Radio with targeted ads received over the Internet from an ad server. Such interest may be based on the desire to provide a user with individualized or regional advertisements and/or may be based on monetary considerations which take into account that, generally, broadcast royalty rates are lower than streaming royalty rates such that combining broadcast over-the-air audio with IP-delivered targeted advertisement may be of financial interest.

There is thus a desire to be able to insert targeted ads into digital audio received from HD Radio broadcasts or other digital broadcasts. However, an HD Radio broadcast audio stream or other digital radio broadcast audio stream already contains advertisements as part of the over-the-air digital broadcast signal. Accordingly, methods and systems are required that seamlessly replace selected ads within an over-the-air digital broadcast signal with alternate, IP-delivered targeted ads. In this respect, also methods and systems are of interest that synchronize an audio stream as broadcast by a radio broadcasting system with the version of that audio stream as received at a broadcast radio receiver so that a seamless user experience is achieved when a broadcast ad is replaced by an IP-delivered targeted ad.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An aspect of the present invention provides for a method for processing an audio broadcast signal in a broadcast radio receiver. The method comprises receiving an over-the-air radio broadcast signal, wherein the received over-the-air radio broadcast signal comprises an audio stream, and wherein the audio stream comprises original advertisement content and other audio content (such as music/speech). The method further comprises receiving an ad insertion start sample count which identifies in the audio stream a first sample of an original advertisement content, wherein the ad insertion start sample count is based on a transmit sample counting implemented at a radio broadcast system broadcasting the over-the-air radio broadcast signal. The ad insertion start sample count may be received through the over-the-air radio broadcast signal, in which case the received over-the-air broadcast signal has been configured at the broadcast system to comprise the ad insertion start sample count. Alternatively, the ad insertion start sample count may be received over the Internet.

The method further comprises receiving a wireless internet protocol signal, the wireless internet protocol signal including targeted advertisement content. The method may further comprise storing the targeted advertisement content in a memory of the broadcast radio receiver. The wireless Internet protocol signal may be received from an ad server. The kind of targeted advertisement, and the motivation for providing the targeted advertisement is not of relevance in the context of the present invention. However, the targeted advertisement received as a wireless internet protocol signal may require format transformation. For example, an IP data stream (such as an MPEG-2 Transport Stream) of the targeted advertisement may be transformed into PCM (Pulse-Code Modulation) samples as known to the skilled person.

The method further comprises implementing receive sample counting by tagging each sample of the audio stream with a receive sample count. Accordingly, the received audio stream samples are counted at the broadcast radio receiver and each sample is tagged with a sample count. In this respect, it is important to note that sample count in audio systems is not stored within the individual samples themselves. Instead, it is managed separately at the broadcast side and at the receiver side by implementing transmitter and receiver counters which are independent from each other. Therefore, the audio stream samples are counted differently at the broadcast/transmitter side and at the reception side.

Accordingly, the receive sample counts are next synchronized with transmit sample counts of the audio stream as counted at the radio broadcast system. This is done by determining an offset between the receive and transmit sample counts, and shifting one of the sample counts by that offset. Embodiments of how that offset is determined are described further below. Generally, any alignment method for aligning the sample counts may be implemented, including simply sending time stamps over the broadcast signal.

When the synchronized receive sample count (i.e., the sample count that considers the previously determined offset) is equal to the ad insertion start sample count, at least a portion of the targeted advertisement content is inserted into the audio stream starting with the sample associated with the ad insertion start sample count, thereby replacing at least some of the original advertisement content by the targeted advertisement content. It is then outputted for audio playback as an audio stream that includes the targeted advertisement content.

Aspects of the invention are thus based on the idea to identify the first sample of an original advertisement content of an audio stream at the broadcast/transmitter side (in a manner that will be discussed below) and to transmit that sample information—termed ad insertion start sample count—to the radio receiver. The radio receiver synchronizes the sample counts and, based on the synchronized sample counts, replaces an original broadcast advertisement content with a targeted IP advertisement content, wherein the targeted IP advertisement content is inserted into the audio stream at the audio sample associated with the ad insertion start sample count. This way, an original broadcast advertisement content is seamlessly replaced by a targeted IP advertisement content. The entire operation is seamless for end users, and end users hear an ad without any awareness that it is a replacement for another ad that originally aired in the broadcast audio stream.

In an embodiment, the synchronization of the receive sample counts with the transmit sample counts of the audio stream is implemented using watermarks. To this end, the over-the-air radio broadcast signal has been further configured at the broadcast system to comprise watermarks embedded into the audio stream, wherein each watermark has a payload which conveys transmit sample count information. The watermark may be embedded periodically into the audio stream. It is sent to the broadcast radio receiver by means of the over-the-air radio broadcast signal. With such prepared audio stream, synchronization of the receive sample counts with the transmit sample counts comprises the steps of extracting the watermarks from the audio stream at the receiver, retrieving the payloads of the watermarks, and synchronizing the receive sample counts with the transmit sample counts by using the watermark payloads to determine an offset between the receive and transmit sample counts.

According to this embodiment, a watermark is not used to indicate the location of the first sample of an original advertisement content that is to be replaced at the radio receiver, but rather to synchronize the transmitter and receiver sample counts/clocks. This is associated with the advantage of relieved reliability and precision requirements on the watermarking algorithm across all audio genres. The payloads of periodically inserted watermarks convey the sample counts associated with the transmitted audio samples. The receiver decodes these watermarks and then synchronizes its local sample count to the decoded tx sample count.

In a further embodiment, the audio stream is structured both at the broadcast/transmitter side and at the radio receiver side in a particular manner. In particular, it may be provided that the transmit audio stream comprises a plurality of synchronization windows, that each synchronization window comprises a number of payload blocks, that each payload block comprises a number of watermark blocks, and that one or more of the watermark blocks comprise a watermark, wherein the value of the payload of each watermark conveys information about the location of that watermark in the transmit audio stream in that the value of the payload of the watermark is equal to the payload block number in which it is located. The receive audio stream similarly comprises a plurality of synchronization windows, each synchronization window comprising a number of payload blocks. In such structured audio stream, the method further comprises to align the boundaries of the transmit and receive synchronization windows by determining a boundary offset Rx_{offset} between the receive and transmit sample counts using the payloads of the watermarks. Subsequently, synchronization window ambiguity is resolved by determining a total offset between the receive and transmit sample counts, as will be discussed further below.

In an embodiment, the received over-the-air radio broadcast signal further comprises an ad insertion stop sample count which identifies in the audio stream a last sample of an original advertisement content, wherein when the synchronized receive sample count is equal to the ad insertion stop sample count, replacing at least some of the original advertisement content by the targeted advertisement content is stopped and the original content of the audio stream is output again.

In an embodiment, the original advertisement content in the audio signal is organized to consist of or include an avail block of one or more contiguous advertisements, wherein the ad insertion start sample count corresponds to the first sample of the avail block or to the first sample of one of the advertisements in the avail block, and wherein the ad insertion stop sample count corresponds to the last sample of the avail block. An avail block thus identifies a group of continuous ads that have been marked as “replaceable”. The individual advertisements contained in an avail block are termed “avails” in the following. All avails in an avail block may be replaced, or a continuous subset of avails in an avail block may be replaced. If an avail block comprises a plurality of contiguous advertisements, the first sample of each of the contiguous advertisements is associated with an ad insertion start sample count.

In case the avail block contains a continuous subset of avails which is less than the total number of ads in the ad block, the continuous subset of avails only may be replaced by the targeted advertisement content, wherein the targeted advertisement content contains a number of replacement ads. In such case, the ad insertion start sample count corresponds to the first sample of the subset (i.e., the first sample of the first avail of the subset), as ad replacement starts with the first avail in the subset.

In a further embodiment, the targeted advertisement content contains a number of replacement advertisements (replacement ads), wherein the replacement ads are resized to be shortened or lengthened in case their total length is longer or shorter than the total length of the continuous subset that is replaced. Such resizing may be implemented such all replacement ads are resized, wherein an error in length is distributed proportionally to each of the available replacement ads. In an alternative embodiment, only the last replacement ad is resized. Resizing may be implemented, e.g., by resampling of the replacement ad(s) such that it/they is/are sped up or slowed down.

In a still further embodiment, the method further comprises transitioning the over-the-air audio stream to outputting targeted advertisement content or transitioning the targeted advertisement content to outputting the original over-the-air content of the audio stream, wherein the transitioning includes applying an amplitude profile in a transition zone of the output audio stream. The application of an amplitude profile in a transition zone ensures that neither original content is played when to be replaced by targeted content, nor that targeted content is played once the transition back to the original content has been effected.

In an embodiment, the method further comprises receiving a start time along with an estimate of the avail block duration in advance. The advance notification may be in milliseconds and may take place several seconds up to several minutes in advance of receiving the ad insertion start sample count. Reception of the start time serves to notify the broadcast radio receiver well in advance that a replacement ad shall be inserted in the near future, which allows the broadcast radio receiver to collect a sufficient number of ads for replacement through a wireless internet protocol hardware communication module. The replacement ads may be stored in an ad inventory. They may contain personalized ads. The advance notification further gives the broadcast radio receiver sufficient time to implement a format transformation, such as from an MPEG-2 format to non-compressed PCM format. The advance notification may also trigger the broadcast radio receiver to start looking for the ad insertion start sample count sent by the broadcaster.

The ad insertion start sample count may be transmitted as metadata of the over-the-air radio broadcast signal. For example, such metadata may be added in an importer or exporter of the broadcasting system.

Generally, tagging the samples of the audio stream with a transmit/receive sample count may comprise tagging each sample of the audio stream with a N-bit unsigned integer sample count which increments by one with each input sample, wherein, if the sample count reaches a maximum value such as 2^{N}−1, it starts counting again from zero. N may be equal to 32 in embodiments.

The present invention may be implemented with digital and analog broadcasts. Accordingly, in one embodiment, the audio broadcast signal is a digital audio broadcast signal and the received over-the-air radio broadcast signal is a digital over-the-air radio broadcast signal. In such case, the ad insertion start sample count may be included in and received through the digital over-the-air radio broadcast signal. Accordingly, the ad insertion start sample count is extracted at the broadcast radio receiver from the received digital over-the-air radio broadcast signal.

In an alternative embodiment, the audio broadcast signal is an analog radio broadcast signal and the received over-the-air radio broadcast signal is an analog radio broadcast signal. In such case, the ad insertion start sample count may also be received through the digital over-the-air radio broadcast signal (using, e.g., the Radio Data System (RDS) communications protocol). Alternatively, it may be received as data packets over the Internet. For example, it may be provided that the ad insertion start sample count (and all other sample counts such as ad insertion stop sample counts discussed below) are sent from a radio broadcasting system as data packets over the Internet to a server, such as an AutoStage server. The sample count information may then be pushed from the server to applicable radio receivers or may be polled from such radio receivers.

A further aspect of the invention provides for a method for providing an audio broadcast signal in a radio broadcasting system. The method comprises providing a transmit audio stream that is to be transmitted, wherein the transmit audio stream comprising original advertisement content and other audio content. A start marker is added to the transmit audio stream, wherein the start marker identifies the beginning of an original advertisement content in the audio stream to be replaced at a broadcast radio receiver. Subsequently, each sample of the transmit audio stream is tagged with a transmit sample count. The start marker in the transmit audio stream is detected and an ad insertion start sample count is determined, wherein the ad insertion start sample count is the sample count at the beginning of the start marker. The ad insertion start sample count may be broadcast with the transmit audio stream in an over-the-air radio broadcast signal or may be sent to a server over the Internet.

This aspect of the invention regards the preparation of the over-the-air radio broadcast signal the reception of which by a broadcast radio receiver has been previously discussed, wherein an ad insertion start sample count is included in the broadcast signal. This is achieved by first appending a start marker to an audio stream at the start of the ad to be replaced. The marker may be silence, an audible chirp, or an inaudible tone in embodiments. This marker is used internally at the radio broadcasting system to reliably detect the start of an ad, wherein the sample count at the location of the marker is determined and represents the ad insertion start sample count which is then included in the broadcast signal and aired to a broadcast radio receiver or sent to the broadcast radio receiver over the Internet. As discussed before, the broadcast radio receiver then recovers the ad insertion start sample count, fetches a targeted IP ad and includes the targeted ad in the receiver audio output when—after synchronization of the transmitted audio stream and the received audio stream—the synchronized receive sample count is equal to the ad insertion start sample count.

This aspect of the invention is based on the realization that the most effective approach to indicate the insertion location in an audio stream is to either append or, alternatively, superimpose a marker to the transmit audio stream at the start of the ad to be replaced. The marker may be added at an audio playout system of the radio broadcasting system before the transmit audio stream is tagged with a transmit sample count. After tagging, the ad insertion start sample count is determined by locating the marker in the transmit sample count. All this takes place at the radio broadcasting system.

As discussed, the ad insertion start sample count is the sample count of the start marker. Accordingly, to determine the ad insertion start sample count, the position of the marker in the transmit audio stream (after tagging) needs to be determined. In an embodiment, this is implemented by determining a signal correlation between the transmit audio stream and a signal which corresponds to the start marker, wherein, if the signal correlation lies above a predetermined threshold, the transmit sample count at the start marker location is defined to be the ad insertion start sample count. For example, the start marker may be a non-audible low frequency audio signal, wherein the signal correlation comprises correlating the transmit audio stream with the low-frequency audio signal. For determining the signal correlation, the transmit audio stream may receive signal processing such as low pass filtering and reduction of the sampling rate before a signal correlation is determined.

In an embodiment, there is also added a stop marker to the transmit audio stream, wherein the stop marker identifies the end of an avail block of original advertisement content in the audio stream that is to be replaced at a broadcast receiver. The stop marker is detected and an ad insertion stop sample count is determined (i.e., by signal correlation as discussed before), wherein the ad insertion stop sample count is the sample count of the beginning of the stop marker. The ad insertion stop sample count is then broadcast or sent over the Internet.

If the original advertisement content in the audio signal is organized to consist of or include an avail block of one or more contiguous advertisements, a plurality of ad insertion start sample counts may be included in the transmit audio stream in the manner discussed, each ad insertion start sample count indicating the first sample of an avail in the avail block, such that the position of each avail that is to be replaced by a corresponding targeted IP ad is included in the broadcast signal and can be recovered at the broadcast radio receiver.

The transmit audio stream may be buffered after detection of the start marker (or any other markers). Buffering serves to allow to include the ad insertion start sample count in the over-the-air radio broadcast signal before the audio stream is transmitted. The buffering may be for a time period of up to 10 seconds in embodiments.

In a further embodiment, a trigger is received from a messaging center of the radio broadcasting system before the step of determining the ad insertion start sample count, wherein the trigger indicates the start of an advertisement content in the audio signal, and wherein determining the ad insertion start sample count is started after having received the trigger. Such trigger thus serves as an internal alert at the radio broadcasting system to become ready for determining the ad insertion start sample count (which may be implemented by determining a signal correlation as discussed before). The mentioned messaging center may be a metadata aggregator and scheduler of the radio broadcasting system.

In an embodiment, the mentioned trigger is received several seconds before the start of an original advertisement content that is to be replaced, wherein the trigger includes the start time of an advertisement block and a program ID identifying the transmit audio stream carrying the original advertisement content.

In a further embodiment, the method further comprises including in the over-the-air radio broadcast signal an advance notification in advance to the scheduling of the original advertisement content that is to be replaced at the broadcast radio receiver. The advance notification may comprise a start time along with an estimate of an avail block duration. The advance notification may be in milliseconds and may take place several seconds up to several minutes in advance of receiving the ad insertion start sample count. Providing the advance notification allows a broadcast radio receiver to prepare for the ad insertion, including collecting a sufficient number of ads for replacement, providing sufficient time to implement a format transformation, and trigger the broadcast radio receiver to start looking for the ad insertion start sample count in the received signal.

Generally, tagging each sample of the transmit audio stream with a transmit sample count may comprise tagging each sample of the transmit audio stream with an N-bit unsigned integer sample count which increments by one with each input sample, wherein, if the sample count reaches a maximum value such as 2N−1, it starts counting again from zero. N may be equal to 32 in embodiments.

In an embodiment, the start marker is removed from the transmit audio stream before broadcasting the audio signal. As the start marker represents an internal means within the radio broadcasting system to identify the beginning of an original advertisement content, namely, to determine the ad insertion start sample count, it is not required to maintain the start marker (or a stop marker) in the audio stream. Accordingly, it may be removed. At the same time, it is also possible to maintain the start marker and any other markers in the audio stream, in particular if the markers are inaudible tones.

Further, the watermarks may be embedded periodically into the transmit audio stream after the step of tagging each sample of the transmit audio stream with a transmit sample count (but not necessarily right after this step). Watermarking the transmit audio stream serves to allow synchronization of the transmit and receive sample counts at a broadcast radio receiver as discussed in more detail in the following.

So far, the present invention has been discussed by considering ad insertion related features that are present at a broadcast radio receiver side and by considering ad insertion related features that are present at a broadcasting side. In the following, a further aspect of the invention is discussed which regards the synchronization of audio samples in a transmitted audio stream and in the corresponding received audio stream, wherein it is to be noted that the respective audio streams have independent sample counts as the sample counts are managed separately and independently at the broadcasting side and at the radio receiver side. Synchronization is required for ad insertion, but may be desired for other reasons as well.

According to this further aspect, a method for synchronizing transmit and receive sample counts of an audio stream is provided for, wherein the method comprises: sample counting of a transmit audio stream to be transmitted, wherein each sample of the transmit audio stream is tagged with a transmit sample count; embedding watermarks in the transmit audio stream, the watermarks having a payload which conveys transmit sample count information; transmitting the transmit audio stream and the watermarks; receiving the audio stream and the watermarks; sample counting of the received audio stream, wherein each sample of the received audio stream is tagged with a receive sample count; extracting the watermarks from the received audio stream at the receiver; retrieving the payload of the watermarks; and synchronizing the receive sample counts with the transmit sample counts by using the watermark payloads to determine an offset between the receive and transmit sample counts.

This aspect of the invention is based on the idea to periodically embed a watermark in an audio stream and transmit the watermark to a broadcast radio receiver, wherein the watermark comprises a payload which conveys information about the sample counts associated with the transmitted audio sample such that an offset between the receive and transmit sample counts can be determined. In particular, each watermark may have a payload the value of which conveys information about the location of that watermark in the transmit audio stream. This allows one to synchronize at the broadcast radio receiver the receive sample count (i.e., the local sample count at the receiver) with the transmit sample count.

It is pointed out that using the watermark payload to determine the offset between the receive and transmit sample counts does not necessarily mean that the offset can be determined solely on the basis of the watermark payload. In embodiments, other information may be required as discussed below. However, the watermark payload is at least one element on the basis of which the offset between the receive and transmit sample counts is determined.

In an embodiment, each watermark is embedded in a block of the transmit audio stream, and wherein the value of the payload identifies the block in which the watermark is embedded. More particularly, it may be provided that the transmit audio stream comprises a plurality of synchronization windows, each synchronization window comprising a number of payload blocks, each payload block comprising a number of watermark blocks, and one or more of the watermark blocks comprising a watermark, wherein the value of the payloads of the watermarks conveys information about the locations of the watermarks in the transmit audio stream in that the value of the payload of a watermark is equal to the payload block number in which it is located. In other words, the value of the payload determines the number of audio samples from the starting edge of a current synchronization window to the payload block containing the watermark.

Further, tagging each sample of the transmit audio stream with a transmit sample count may comprise tagging each sample of the transmit audio stream with a N-bit unsigned integer sample count having bits [N-1, N-2, . . . , M, . . . , K, . . . , 0] which increments by one with each input sample, wherein, if the sample count reaches a maximum value, it starts counting again and increments by one with each input sample. The payload of the watermark is bit K through bit M of the N-bit unsigned integer sample count. N may be equal to 32, K may be equal to 12, and M may be equal to 19, in which case the payload is an 8-bit payload.

The payload of the watermark is embedded in one of the samples of a watermark block. By reading that sample at the broadcast radio receiver, the payload of the watermark can be retrieved. In this context, it is pointed out that the watermarking process itself may be carried out by means of state-of-the-art watermarking tools known to the skilled person.

In an embodiment, synchronization includes aligning the boundaries of the synchronization windows by determining a boundary offset Rx_{offset} between the receive and transmit sample counts using the payload of the watermark.

After aligning the boundaries of the synchronization windows, as a further step to achieve full synchronization of the transmit and receive audio streams synchronization window ambiguity may be resolved by determining a N-bit total offset between the receive and transmit sample counts, wherein the N-bit total offset may be determined by:
transmitting an N-bit transmit start sample count within the transmit audio signal, wherein the transmit start sample count is L_{Tstart};
retrieving the N-bit transmit start sample count at the receiver, wherein the receive start sample count, the receive sample count at time of retrieval, is L_{Rstart};
determining the synchronization window number t in which the transmit sample count L_{Tstart} is located; determining the synchronization window number r in which the receive sample count L_{Rstart} is located;
wherein the transmit sample count is received within a time at the receiver which corresponds to the length of the synchronization windows,
wherein the N-bit total offset is determined using r, t and the boundary offset Rx_{offset}.

Accordingly, the receive synchronization window boundaries are first aligned with the transmit synchronization window boundaries by adding Rx_{offset}. This sample count is then adjusted by subtracting the number of samples between L_{Tstart} and its transmit synchronization window start boundary. This allows for L_{Rstart} to be received anywhere within a synchronization window without affecting the upper bits of the modified receive sample count. A full synchronization window number of samples minus 1 is added to the modified Rx sample count to place it within the correct synchronization window, since it had arrived at the receiver up to (but not including) a synchronization window early. The Rx synchronization window number is then set to the upper N bits of the modified Rx sample count. The final Rx offset can be constructed using r, t and the boundary offset Rx_{offset}.

A still further aspect of the invention regards a radio receiver. the radio receiver comprises:
an over-the-air radio broadcast hardware communication module configured to receive an over-the-air radio broadcast signal, the over-the-air radio broadcast signal comprising an audio stream, the audio stream comprising original advertisement content and other audio content;
a wireless internet protocol hardware communication module configured to receive a wireless internet protocol signal, the wireless internet protocol signal including targeted advertisement content;
processing circuitry; and
a client application including instructions for execution by the processing circuitry, wherein the client application is configured to:
receive an ad insertion start sample count which identifies in the audio stream a first sample of an original advertisement content, wherein the ad insertion start sample count is based on a transmit sample counting implemented at a radio broadcast system broadcasting the over-the-air radio broadcast signal;
implement receive sample counting by tagging each sample of the audio stream with a receive sample count;
synchronize the receive sample counts with transmit sample counts of the audio stream as counted at the radio broadcast system by determining an offset between the receive and transmit sample counts;
when the synchronized receive sample count is equal to the ad insertion start sample count, insert at least a portion of the targeted advertisement content into the audio stream starting with the sample associated with the ad insertion start sample count, and replace at least some of the original advertisement content by the targeted advertisement content; and
output an audio stream that includes the targeted advertisement content.

Embodiments of the radio receiver are identified in the appended claims.

A still further aspect of the invention regards a radio broadcast system. The radio broadcast system comprises:
an audio playout system which is configured to provide a transmit audio stream that is to be transmitted, wherein the transmit audio stream comprises original advertisement content and other audio content, and to add a start marker to the transmit audio stream, the start marker identifying the begin of an original advertisement content in the audio stream to be replaced at a broadcast radio receiver;
an ad insertion client configured to tag each sample of the transmit audio stream with a transmit sample count, to detect the start marker in the transmit audio stream and determine an ad insertion start sample count, the ad insertion start sample count being the sample count at the beginning of the start marker; and
a radio transmission system configured to broadcast the ad insertion start sample count with the transmit audio stream or send the ad insertion start sample count to a server over the Internet.

Embodiments of the radio broadcast system are identified in the appended claims.

A still further aspect of the invention regards a system for synchronizing transmit and receive sample counts of an audio stream. The system comprises:
a transmitter configured to sample count a transmit audio stream to be transmitted, wherein each sample of the transmit audio stream is tagged with a transmit sample count, to embed watermarks in the transmit audio stream, each watermark having a payload which conveys transmit sample count information, and to transmit the transmit audio stream and the watermarks,
a receiver configured to receive the audio stream and the watermarks, to sample count the received audio stream, wherein each sample of the received audio stream is tagged with a receive sample count, to extract the watermarks from the received audio stream at the receiver, to retrieve the payloads of the watermarks, and to synchronize the receive sample counts with the transmit sample counts by using the watermark payloads to determine an offset between the receive and transmit sample counts.

Embodiments of the system for synchronizing transmit and receive sample counts of an audio stream are identified in the appended claims.

The language “configured” indicates that the respective entity may comprise processing circuitry, a memory and software that when executed by the processing circuitry implements the identified function.

Further aspects of the invention regard a computer program product embodied on a non-transitory computer readable medium comprising instructions stored thereon to cause one or more processors to carry out the method of any of claims 1 to 13, a computer program product embodied on a non-transitory computer readable medium comprising instructions stored thereon to cause one or more processors to carry out the method of any of claims 14 to 24, and a computer program product embodied on a non-transitory computer readable medium comprising instructions stored thereon to cause one or more processors to carry out the method of any of claims 25 to 34.

Embodiments of the present invention may be implemented for virtually any analog or digital radio broadcasting system, such as HD Radio™, DAB+, DRM, CDR, and many others.

### BRIEF DESCRIPTION OF THE DRAWINGS

Throughout the drawings, reference numbers are re-used to indicate correspondence between referenced elements. The drawings are provided to illustrate embodiments of the inventions described herein and not to limit the scope thereof.

FIG. 1 is a block diagram of an embodiment of an ad insertion system which comprises a radio broadcast transmitter system and a radio receiver;

FIGS. 2 to 9 indicate transmit and receive audio streams at different stages of their synchronization in accordance with a synchronization embodiment;

FIG. 10 indicates the steps of a method for synchronizing transmit and receive sample counts of an audio stream;

FIG. 11 is a block diagram of an embodiment of a radio broadcasting system;

FIG. 12 is an example of an audio stream which comprises an avail block for ad insertion, wherein start and stop markers around the avail block are inserted into the audio stream and wherein avail start markers at the beginning of the avails are superimposed on the audio stream;

FIGS. 13 to 15 show examples of the contents of raw data XML files received at a metadata aggregator and scheduler of a radio broadcasting system and messaging provided by the metadata aggregator and scheduler;

FIG. 16 is a block diagram of an embodiment of a subsystem in a radio broadcasting system for detecting a start or stop marker in a transmit audio stream and determining an associated ad insertion start sample count using signal correlation;

FIGS. 17 to 19 show embodiments of the contents of raw data XML files provided at a radio broadcasting system from an audio playout system and messaging provided by the metadata aggregator and scheduler;

FIG. 20 indicates the steps of a method for providing an audio broadcast signal in a radio broadcasting system;

FIG. 21 is a block diagram of an embodiment of a broadcast radio receiver;

FIGS. 22 to 26 show an example audio stream which comprises an avail block for ad insertion, wherein the avail block comprises a continuous subset of avails, wherein a continuous subset of avails is replaced by a corresponding number of targeted ads, and wherein the replacement ads are resized;

FIGS. 27 to 35 show exemplary embodiments of transitions in an audio stream from an avail block start marker to a replacement ad or from a replacement ad to the start of an avail block stop marker; and

FIG. 36 indicates the steps of a method for processing an audio broadcast signal in a broadcast radio receiver.

### DETAILED DESCRIPTION

The following description describes various embodiments of methods and systems that relate to the replacement of advertisements received over an over-the-air radio broadcast signal by IP-delivered targeted advertisements.

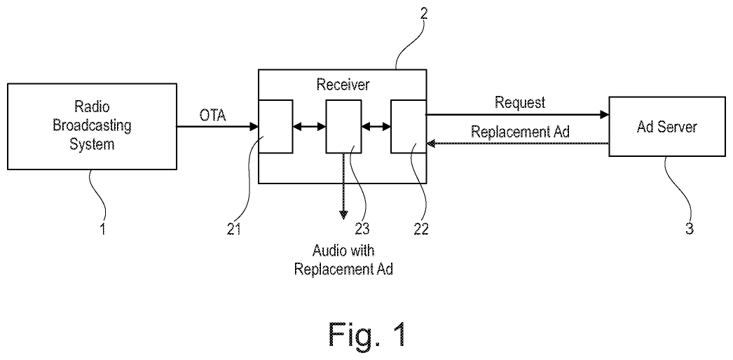

FIG. 1 is a functional block diagram of a system that comprises a radio broadcasting system, also referred to as broadcasting system, broadcast side or transmitter. The radio broadcasting system is configured to broadcast a over-the-air radio broadcast signal OTA. The system further comprises a broadcast radio receiver 2, also referred to as radio receiver, receiver or receiver side.

The radio receiver 2 comprises an over-the-air radio broadcast hardware communication module 21 which is configured to receive the over-the-air radio broadcast signal OTA broadcast by the radio broadcasting system 1. The radio receiver 2 further comprises a wireless internet protocol hardware communication module 22 which is configured to receive a wireless internet protocol signal. In particular, the communication module 22 is connected to an ad server 3 which contains a plurality of advertisements. Upon request of the radio receiver 2, advertisements (ads) are received from the ad server 3 through a wireless internet protocol signal, which may be an MPEG-2 IP data transport stream or other IP data stream. The received ads may be stored in an ad storage memory (not shown) of the receiver 1. The ads are received for the purpose of replacing ads that are contained in the OTA broadcast and thus termed replacement ads or targeted ads.

The over-the-air radio broadcast hardware communication module 21 may comprise an antenna, a tuner and a baseband processor as known to the skilled person. The wireless internet protocol hardware communication module 22 may comprise a wireless IP interface managed by a host controller. An example over-the-air radio broadcast hardware communication module and an example wireless internet protocol hardware communication module are described in document WO 2017/184963 A1, the entire content of which is incorporated herewith by reference. Further, it is pointed out that the radio receiver 2 may comprise further components such as front-ends, speakers, remote controls, and input/output devices.

The radio receiver 2 further comprises processing circuitry 23 and a client application including instructions for execution by the processing circuitry 23. The processing circuitry 23 is configured to replace ads received by the OTA broadcast with targeted replacement ads received from the ad server 3 in a seamless manner, as will be apparent from the subsequent description. The receiver 2 outputs audio which comprises the replacement ads.

Based on the infrastructure generally described with respect to FIG. 1, the present invention thus addresses the problem of seamlessly replacing an original advertisement content contained in an audio stream received by an OTA broadcast with targeted advertisement content received over the Internet.

Ad insertion within the context of OTA radio ad replacement requires a design method capable of achieving a sound quality acceptable to the average listener. There are two aspects that need to be addressed: First, the timing accuracy between the OTA Ad and the replacement Ad which requires a synchronization between the transmitted and the received audio streams, and second, the physical transitioning between them. The following chapter I. regards embodiments of providing timing accuracy between the OTA Ad and the replacement Ad. Chapter II. regards embodiments to provide physical transitioning between the ads as far as the broadcasting side is involved. Chapter III. regards embodiments to provide physical transitioning between the ads as far as the receiver side is involved. Chapter IV discusses examples of specific ad insertion transition designs.

### I. Ad Insertion Synchronization

With the goal of replacing “over the air” broadcast advertisements with targeted IP-based advertisements at the receiver, a method of synchronizing the advertisements is required. An example method uses watermarking. The watermarking is used to convey transmitter audio sampling information to the receiver which can then be used to synchronize receiver audio sampling. The goal is accuracy within 100 msec while taking less than five minutes to synchronize.

### Transmit Timing

The broadcasting system/transmitter may contain an audio stream that is a dual channel (16-bit left, 16-bit right) PCM stream at a sample rate of 44.1 kHz. Every sample will be time tagged with a sample count using a 32-bit unsigned integer. This integer, Tx_{samplecount}, will count upward until it reaches a value of 2³²−1 (approximately 27 hours). At this point, the next sample will cause the counter to roll over to 0 and the counter will continue incrementing from there.

A watermarking algorithm places an 8-bit payload within a watermark block of 512 audio samples. It has been determined that the payload should be bit 12 through 19 of the 32-bit Tx sample count as follows: [31, 30, . . . 0], where bit 31 is the MSB (Most Significant Bit). The mathematical formula is given by Equation 1.

Px=Floor ((tx_{samplecount} Mod 2²⁰)/2¹²) (1)

where px is the 8-bit payload block number, which is also the value of the payload. This provides the possibility of having 8 consecutive watermark blocks producing payloads with the same value every 4096 samples. Blocks of 2¹² samples=4096 samples are labeled as payload blocks. This means that every 2²⁰ samples, the sequence of payload values would repeat itself. For simplicity, each block of 2²⁰ samples (a duration of roughly 23 seconds) is labeled a synchronization window. Every synchronization window will contain 256 payload blocks with a corresponding payload value. Every synchronization window will have its own window number and there will be 2¹² unique window values. The time relationship between synchronization window and payload block is chosen to accommodate a synchronization window long enough to resolve synchronization window number ambiguity and to require a payload block small enough to meet the 100 msec timing accuracy.

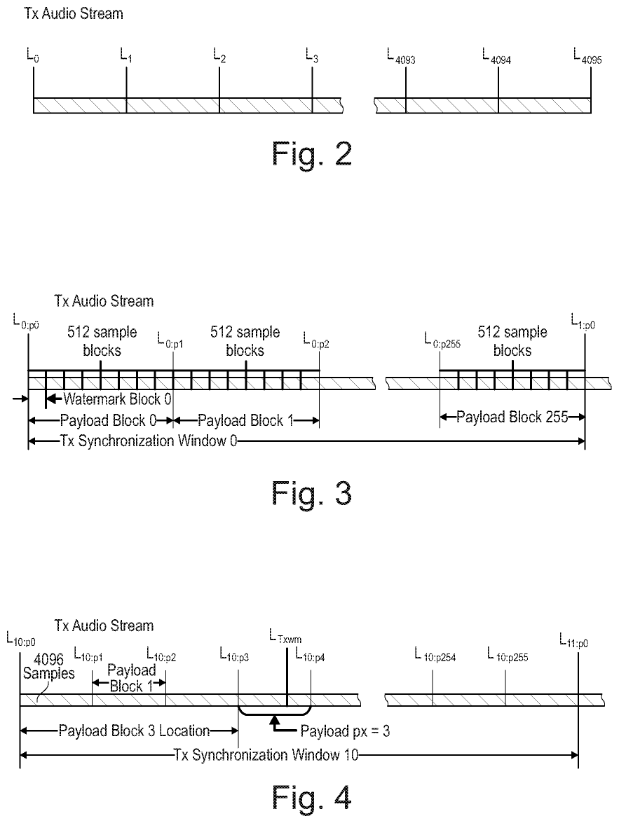

The audio stream synchronization windowing is shown in FIG. 2, wherein Lₜ is the sample count of the first sample within a Tx synchronization window and t is the Tx sync window number as defined by Equation 2:

T=Floor (tx_{samplecount}/2²⁰) (2)

FIG. 3 indicates the Tx Audio Stream showing Payload and Watermark Blocks within a Synchronization Window. Lₜ: ₚₓ is the sample count of the first sample within a payload block, t is the Tx synchronization window number and px is the payload block number as defined by Equation 1.

When a watermark is placed on the Tx Audio Stream, L_{Txwm} is set to the Tx_{samplecount} of the watermark. This is then used in Equation 1 to compute a payload value px. The value of px determines the number of audio samples from the starting edge of the current synchronization window to the starting edge of the payload block containing the watermark; see FIG. 4 which shows the Tx Sample Count of the watermark and the corresponding payload. The px payload is embedded within the audio watermark and is sent over the air to the receiver.

### Receive Timing

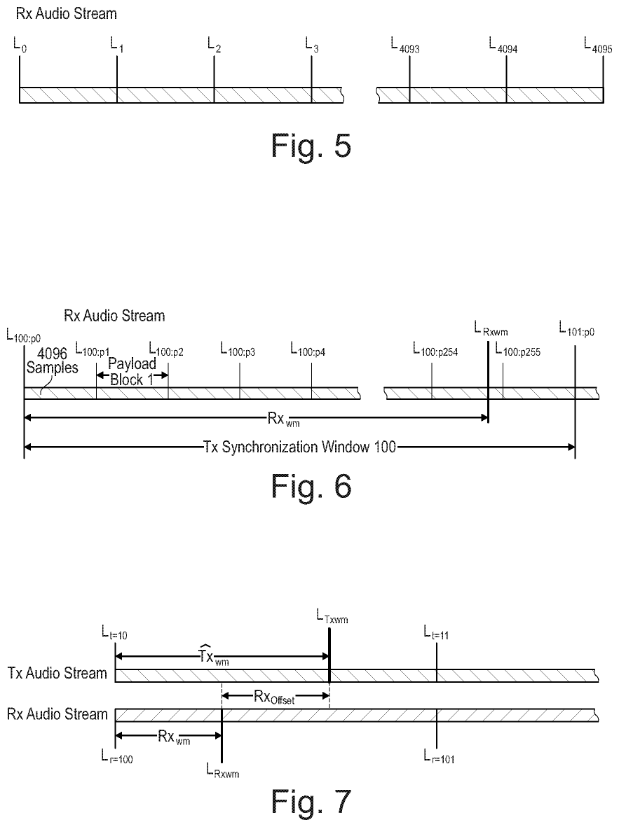

The receiver has an independent sample counter that mimics the transmitter sample counter. It has the same audio sample rate of 44.1 kHz and contains the same dual channel 16-bit PCM format. Its sample counter, Rx_{samplecount}, is a 32-bit unsigned integer with modulo 2³² counting and has the same synchronization window size as the transmitter. The Rx audio stream synchronization windowing is shown in FIG. 5. Lᵣ is the sample count of the first sample within an Rx synchronization window and r is the window number as defined by Equation 3:

R=Floor (rx_{samplecount}/2²⁰) (3)

The receiver will attempt to detect the transmitted watermark within its own independently sampled audio stream. The Rx_{samplecount} at the location of the detected watermark is denoted by L_{Rxwm}, as shown in FIG. 6 which shows the Rx Sample Count Location of the detected watermark. Following the examples in FIG. 4 and FIG. 6, the watermark transmitted at location L_{Txwm} in Tx payload block 3 within Tx synchronization window 10 is received in payload block 254 within Rx synchronization window 100. The receiver must use the recovered Tx payload to determine the offset between the Tx and Rx sample counters.

In FIG. 6, Rx_{wm} represents the number of receiver audio samples from the starting edge of the current Rx synchronization window to the location of the detected watermark. Rx_{wm} is simply the 20 LSBs of the watermark location L_{Rxwm}:

Rx_{wm}=L_{Rxwm} Mod 2²⁰ (4)

Equation 4 illustrates calculating the 20 LSBs of the Watermark Location.

### Tx/Rx Synchronization Window Alignment

The first step in synchronizing the Tx and Rx sample counters is to align the boundaries of the synchronization windows, Lₜ and Lᵣ. When a watermark is detected and its location within the Rx sample stream is found, the payload px is extracted and validated. The 8-bit payload is converted to a 20-bit estimate of the Tx watermark location, relative to the start of the Tx synchronization window that contained the watermark (see Equation 5). The maximum estimate error is halved by placing the estimate in the center of payload block px by adding 2¹¹. This addend effectively fills in the lower 12 bits of the 20-bit estimate.

[symbol]

_{wm}=(px*2¹²)+2¹¹ (5)

Equation 5 provides calculating the Estimate of the Tx Watermark Location.

Since it is known that the watermark did not change its location within the audio stream, it is possible to align the starting sample of the Tx synchronization window containing the watermark with the starting sample of an Rx synchronization window where, or adjacent to where, the watermark was detected, as defined in Equation 6. The addition of 2²⁰ ensures that the offset is a positive number.

Rx_{offset}=(( [symbol] _{wm}−Rx_{wm})+2²⁰)MOD 2²⁰ (6)

Equation 6 regards calculating the Rx_{offset}.

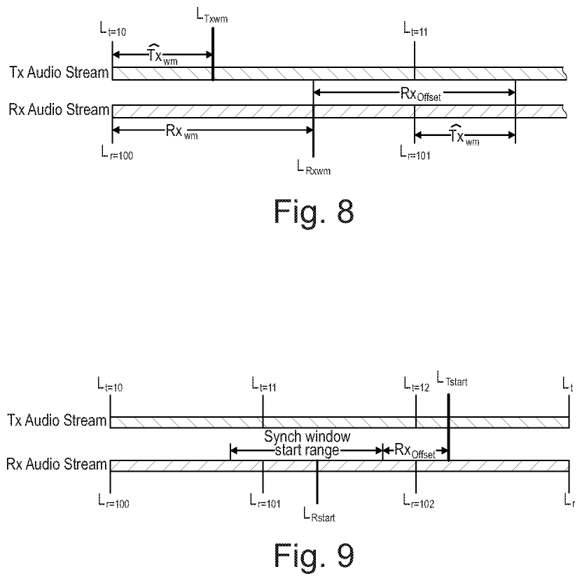

This offset Rx_{offset} could result in one of two possible synchronization alignments, as illustrated in FIGS. 7 and 8, wherein FIG. 7 shows the Tx Synchronization Window Aligned with a current Rx Synchronization Window and FIG. 8 shows the Tx Synchronization Window Aligned with the next Rx Synchronization Window. The Lᵣ and Lₜ locations are selected as an example.

Rx_{offset} must be applied to Rx_{samplecount} before any subsequent processing. Rx_{offset} is then input to a median filter followed by a loop filter to drive the estimation error to zero. Once the median filter is full, the window synchronization flag is set, indicating that the Tx and Rx synchronization window boundaries are aligned. The median filter serves to discard any outlier Rx_{offset} values. The loop filter may provide negative feedback to drive Rx_{offset} error to zero, as in a phase-locked-loop.

### Synchronization Window Ambiguity Resolution

The synchronization window alignment process ensures that the boundaries of the Tx and Rx synchronization windows are coincident. However, the synchronization window numbers could still differ by an integer multiple of 2²⁰ audio samples, as shown in FIGS. 8 and 9, where Lₜ₌10 and Lᵣ=100. In other words, even though the lower 20 bits of the Tx and Rx sample counters have been reconciled, the upper 12 bits have not.

The synchronization window number ambiguity resolution requires that a 32-bit sample count value be passed from the transmitter to the receiver. This is effected by transmitting the 32-bit start sample count of an avail block to the receiver over the HD Radio transport, as will be described further below. The start sample count must be received within 23.8 seconds (2²⁰ audio samples) of the arrival of the associated audio (but not after). FIG. 9 shows an example of the transmission and receipt of the start sample count and indicates the range of Rx Sample Counts required of L_{Rstart} for resolution of Tx and Rx Synchronization Window Values.

L_{Tstart} is the 32-bit sample count of the first sample in the avail block, and L_{Rstart} is the 32-bit sample count indicating when L_{Tstart} is available to the receiver. L_{Rstart} must lie within the synchronization window start range shown in FIG. 9.

t=floor (L_{Tstart}/2²⁰) (7)

Equation 7 defines calculating the Tx Synchronization Window Number, t.

r=floor ((L_{Rstart}+R_{xoffset}−(L_{Tstart}MOD 2²⁰)+(2²⁰−1))/2²⁰) (8)

Equation 8 defines calculating the Rx Synchronization Window Number, r.

In the above equations, t is the Tx synchronization window number and r is the Rx synchronization window number. The receive synchronization window boundaries are aligned with the Tx synchronization window boundaries by adding Rx_{offset}. This sample count is then adjusted by subtracting the number of samples between L_{Tstart} and its Tx synchronization window start boundary. This allows for L_{Rstart} to be received anywhere within a synchronization window without affecting the upper 12 bits of the modified Rx sample count. A full synchronization window number of samples minus 1 is added to the modified Rx sample count to place it within the correct synchronization window, since it had arrived at the receiver up to (but not including) a synchronization window early. The Rx synchronization window number is then set to the upper 12 bits of the modified Rx sample count. The final Rx offset can now be constructed as shown in Equation 9.

Rx_{totalOffset}=((t−r+2¹²)MOD 2¹²)*2²⁰+Rx_{offset} (9)

Equation 9 defines calculating the Final Rx Offset.

The difference between the Tx and Rx synchronization window numbers is a 12-bit integer that is shifted to the upper 12 bits of the 32-bit total offset. The synchronization window alignment offset is represented by the lower 20 bits of the total offset.

The estimated Tx sample count [symbol] _{samplecount} can now be calculated by simply adding Rx_{totalOffset} to the current Rx sample count, as shown in equation 10:

[symbol]

_{samplecount}=(Rx_{samplecount}−Rx_{totalOffset})MOD 2³² (10)

Equation 10 defines calculating the Estimated Tx Sample Count.

### EXAMPLE

The above calculations and considerations are further explained by providing an example of calculating the Rx_{totalOffset}.

It is assumed that:
Tx_{samplecount}=0 (0x00000000)
Rx_{samplecount}=4201005558 (0xFA6641F6)
L_{Txwm}=11217920 (0x00ab2c00)
Payload px=178
L_{Rxwm}=105177610 (0x0644e20a)
L_{Tstart}=12789770 (0x00c3280a)
L_{Rstart}=106521098 (0x0659620a)

Per Equation 5, calculate an estimate of the distance from the start of the Tx synchronization window containing the Tx watermark to the location of the Tx watermark using the extracted payload from the detected Tx watermark located at L_{Rxwm}.

[symbol]

_{wm}=(Px*2¹²)+2¹¹=(178*2¹²)+2¹¹=731136 (0xb2800)

Per Equation 4, calculate the distance from the start of the Rx synchronization window containing the detected Tx watermark L_{Rxwm} to the location of the detected Tx watermark by extracting the lower 20 bits of L_{Rxwm}.

Rx_{wm}=L_{Rxwm}Mod 2²⁰=105177610 Mod 2²⁰=320010 (0x4e20a)

Per Equation 6, find the value needed to align the boundaries of the Tx and Rx synchronization windows:

Rx_{offset}=(( [symbol] _{wm}−Rx_{wm})+2²⁰) MOD 2²⁰=((731136−320010)+2²⁰) MOD 2²⁰=411126 (0x645f6)

Per Equation 7, find Tx synchronization window number by extracting the upper 12 bits of L_{Tstart}:

T=Floor(L_{Tstart}/2²⁰)=Floor(12789770/2²⁰)=12 (0x00c)

Next, align the Rx synchronization window boundaries with the Tx synchronization window boundaries by adding the Rx_{offset} to L_{Rstart}:

adjusted L_{Rstart}=L_{Rstart}+Rx_{offset}=106521098+411126=106932224 (0x065fa800)

Then, find the distance from the Tx synchronization window boundary to L_{Tstart} by extracting the lower 20 bits of L_{Tstart} and subtract it from the adjusted L_{Rstart}:

adjusted L_{Rstart}=adjusted L_{Rstart}−(L_{Tstart} Mod 2²⁰)=106932224−(12789770 Mod 2²⁰)=106725366 (0x065c7ff6)

Next, calculate r by adding 1 sample less than a full synchronization window to the adjusted LRstart and extracting its upper 12 bits:

r=floor((adjusted L_{Rstart}+(2²⁰−1))/2²⁰)=floor((106725366+(2²⁰−1))/2²⁰)=102 (0x066)

Next, per Equation 9, calculate the ambiguity between the Tx and Rx synchronization window numbers by subtracting the Rx synchronization window number from the Tx synchronization window number, making sure that the answer is a positive 12-bit number:

Window difference=((t−r+2¹²) MOD 2¹²)=((12−102+2¹²) MOD 2¹²)=4006 (0xfa6)

Now, knowing the window difference, the final Rx offset can be constructed by placing the 12-bit window difference in the upper 12 bits of a 32-bit number and placing Rx_{offset} in the lower 20 bits of the same 32-bit number:

Rx_{totalOffset}=(window difference)*2²⁰+Rx_{offset}=(4006*2²⁰)+411126=4201006582 (0xfa6645f6)

Adjusting Rx_{samplecount} by Rx_{totalOffset} per Equation 10, the resulting estimated [symbol] _{samplecount} will contain an error of −1024 samples due to the resolution of the offset 4096-sample payload block.

[symbol]

_{samplecount}=(Rx_{samplecount}−Rx_{totalOffset}) MOD 2³²=(4201005558−4201006582) MOD 2³²=−1024

This estimate, which lies within the ±2048-sample error bound, is equivalent to about 23.2 msec: it lies well within the 100-ms ad insertion synchronization specification.

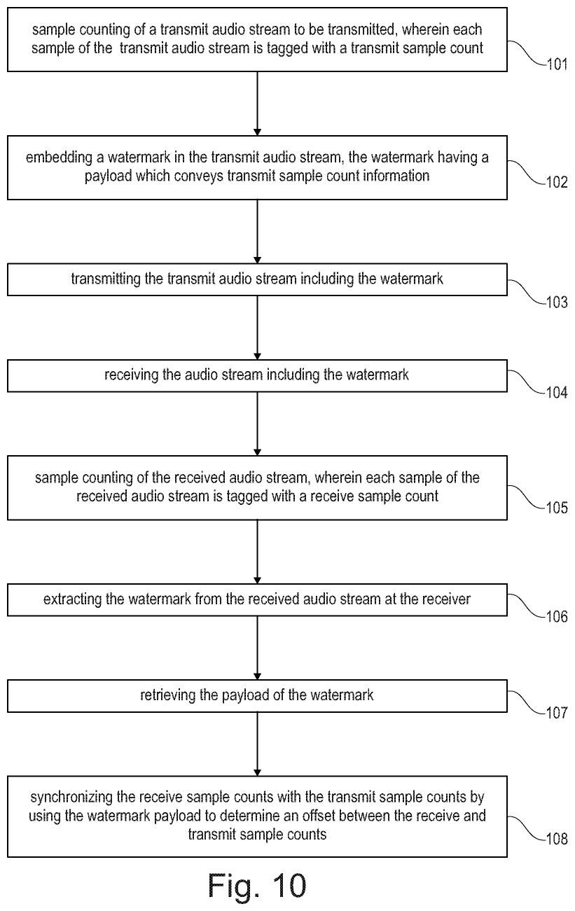

Aspects of the synchronizing method explained with respect to FIGS. 2 to 9 are summarized in the flowchart of FIG. 10. In step 101, samples of a transmit audio stream to be transmitted are counted, wherein each sample of the transmit audio stream is tagged with a transmit sample count. In step 102, a watermark is embedded in the transmit audio stream, the watermark having a payload which conveys transmit sample count information, see FIG. 4. In step 103, the transmit audio stream including the watermark is transmitted to a receiver and in step 104 the audio stream including the watermark is received. In step 105, the samples of the received audio stream are counted, wherein each sample of the received audio stream is tagged with a receive sample count. See FIGS. 5 and 6 for steps 104 and 105. In step 106, the watermark is extracted from the received audio stream at the receiver, and in step 107 the payload of the watermark is retrieved, see FIGS. 7 and 8. In step 108, the receive sample counts are synchronized with the transmit sample counts by using the watermark payload to determine an offset between the receive and transmit sample counts, as discussed with respect to FIG. 9.

### II. Physical Transitioning—Broadcasting System

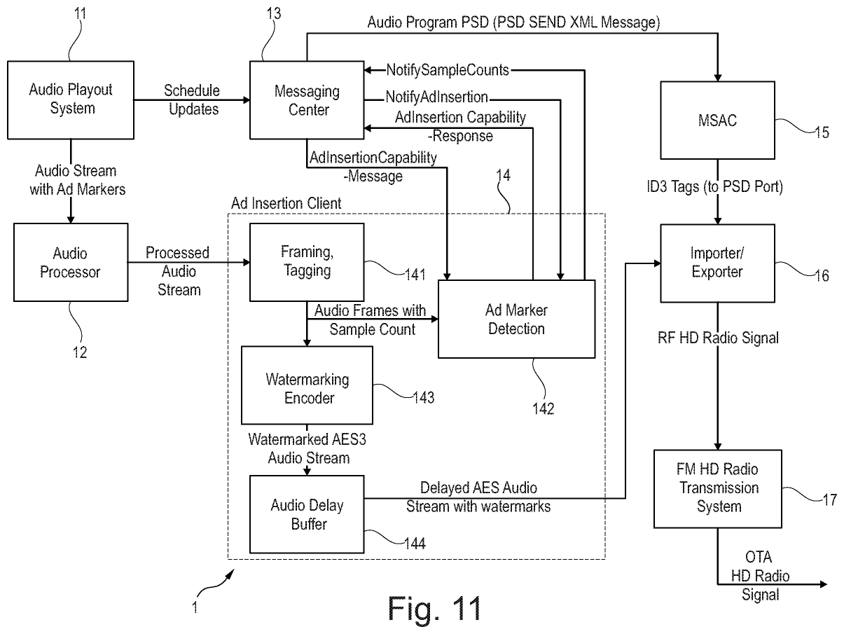

Next, the radio broadcasting system 1 of FIG. 1 is discussed in more detail. FIG. 11 shows the system architecture. The radio broadcasting system 1 comprises an audio playout system 11, an audio processor 12, a messaging center 13, an ad insertion client 14, an MSAC client 15, an importer/exporter 16, and a radio transmission system 17 which may be an HD radio transmission system.

The audio playout system 11 provides a transmit audio stream that is to be transmitted to a receiver. The transmit audio stream may be applied to main program service (MPS) audio or a supplemental program service (SPS) audio. The transmit audio stream comprises an original advertisement content and other audio content, wherein the original advertisement content may be replaced at the receiver. To identify the original advertisement content that may be replaced, a start marker is added to the transmit audio stream, wherein the start marker identifies the beginning of an original advertisement content in the audio stream. The start marker may be silence, an audible chirp or an inaudible tone. Further, other markers such as a stop marker may be added to the audio stream. All these markers are referred to as ad markers. The audio stream with the ad markers is provided through the audio processor 12 which processes the audio stream and sends it to the ad insertion client 14.

The ad insertion client 14 comprises a block 141 for framing and tagging the processed audio stream. In particular, each sample of the transmit audio stream is tagged with a transmit sample count. Ad insertion client 14 further comprises an ad marker detection block 142. In the ad marker detection block 142, the start marker and other ad markers that have been added to the audio stream in the audio playout system 11 are detected and an ad insertion start sample count which is defined as the sample count at the beginning of the detected start marker is determined. The determined ad insertion start sample count is conveyed to the messaging center 13 as will be discussed in more detail below.

The ad insertion client 14 further comprises a watermarking encoder 143. The watermarking encoder 143 periodically embeds watermarks in the audio stream, for the synchronization purpose as discussed with respect to FIGS. 2 to 10.

The ad insertion client 14 further comprises an audio delay buffer 144 in which the audio stream is buffered for a predetermined amount of time such as up to 30 seconds. The buffering serves to allow the ad insertion start sample count determined by the ad marker detection block 142 to arrive at the radio receiver through the messaging center 13 in advance of the associated audio.

The delayed audio stream with watermarks is provided from ad insertion client 14 to importer/exporter 16. The importer/exporter 16 is configured to prepare and send audio and data content to the transmission system 17. It handles tasks such as encoding, compressing, and formatting the audio signal to ensure it meets the required standards for broadcast. It also includes metadata received from MSAC 15 in the data to be transmitted. Importers/Exporters are well known to the skilled person and, therefore, not further discussed here. The radio transmission system 17 broadcasts the radio signal received from the importer/exporter 16 as an over-the-air radio broadcast signal.

The messaging center 13 represents a metadata aggregator and scheduler and supervises the provision of metadata, which are provided to exporter 16 through MSAC client 15. The messaging center also receives through the message “NotifySampleCounts” the information from the ad marker detection block 142 about the ad insertion start sample count and other ad insertion sample counts. This information is provided to MSAC client 15 and importer/exporter 16 and included as a metadata in the over-the-air broadcast signal such that it can be retrieved at the radio receiver.

The MSAC client 15 manages the transmission of data services and metadata to the importer/exporter.

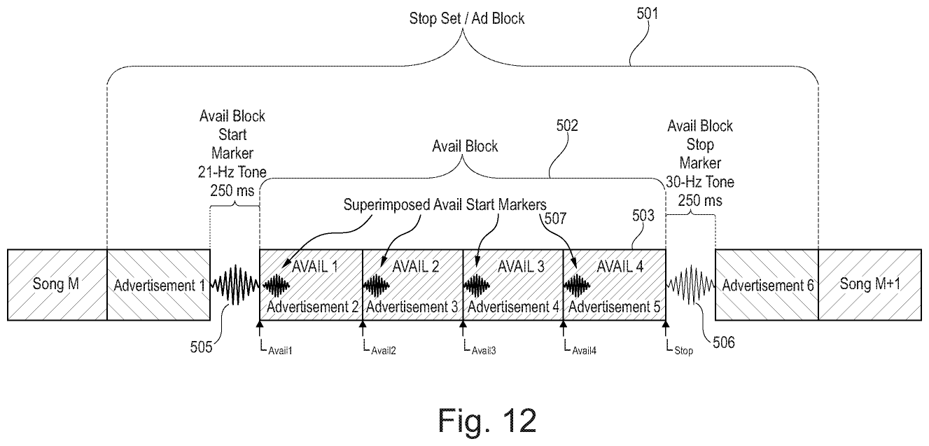

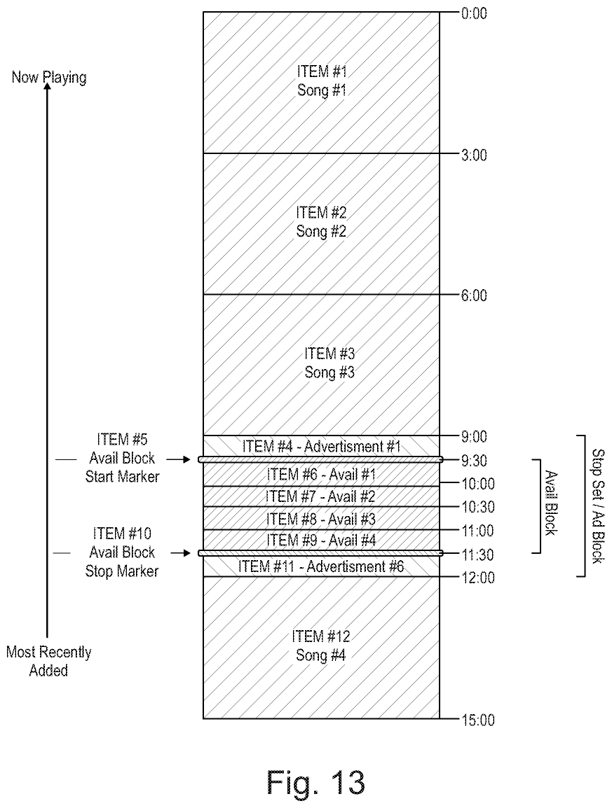

Before discussing details of the radio broadcasting system 1 with reference to FIGS. 13 to 19, the structure of the audio stream to be transmitted is first discussed with respect to FIG. 12. The audio stream is a sequence of audio samples, wherein the audio samples convey different content which includes original advertisement content and other audio content. For example, FIG. 12 shows as other audio content a song M before an ad block and a song M+1 after the ad block. The original advertisement content is marked by a stop set which defines the borders of an ad block 501. In the depicted embodiment, but not necessarily, not all of the ads in ad block 501 are available for a replacement. In the depicted example, advertisement 1 and advertisement 6 are not available for replacement. The ads available for replacement at a radio receiver are arranged in an avail block 502. The avail block 502 comprises a plurality of contiguous replaceable ads (avails) 503, in the depicted embodiment four avails. Before the avail block 502, an avail block start marker 505 is inserted into the audio stream which may be an inaudible tone such as a 21 Hz tone which lasts 250 ms. After the avail block 502, an avail block stop marker is inserted into the audio stream which also may be an inaudible tone such as a 30 Hz tone which lasts 250 ms. Further, at the beginning of each avail 503, a superimposed avail start marker 507 is superimposed. The superimposed start marker 507 may also be an inaudible tone.

The audio stream depicted in FIG. 12 is the audio stream which leaves the audio playout system 11 of FIG. 11. In the audio playout system 11, the avail block start marker 505, the superimposed avail start markers 507 and the avail block stop markers 506 have been added. Alternatively, these markers could be added before or after the audio playout system 11 by other means/equipment.

In the ad marker detection block 142 of ad insertion client 14, the different markers 505, 506 and 507 are detected and their position in the audio stream is detected by determining their sample count. Of particular importance is the sample count at the location of the start markers which are labeled as L_{Avail1} to L_{Avail 4} in FIG. 12. L_{Avail1} to L_{Avail4} represent ad insertion start sample counts which are determined in block 142 and conveyed to the messaging center 13 for inclusion in the over-the-air broadcast radio signal. Accordingly, the start sample counts L_{Avail1} to L_{Avail 4} are determined in ad marker detection block 142 by determining the location of the respective markers 507. In a similar manner, a stop marker sample count L_{Stop} is determined based on avail block stop marker 506. The only or at least the main reason for inserting the ad markers 505, 506, 507 in the audio stream in audio playout system 11 (at a time when the audio stream samples have not yet been tagged) is to provide a basis for determining the sample count at the beginning of the replaceable ad in add marker detection block 142. For that reason, after the sample counts have been determined in block 142, in embodiments, the ad markers 505, 506 and 507 may be removed from the audio stream. However, they may also remain in the audio stream and be used, e.g., for providing transition windows between original content and replaced content.

The following, further details of the radio broadcast system 1 are discussed.

### Audio Playout System

In embodiments, the Audio Playout System 11 provides to the Ad Insertion Client 14 a stereo 44.1-kHz PCM full-scale (0-dBFS) digital audio stream with avail start and stop markers inserted. Avails, for example, may have a nominal length of 30 seconds. Audio Playout System 11 inserts, immediately preceding each avail block, a start marker consisting, e.g., of a 21-Hz tone of duration 250 msec and level −10 dBFS. The beginning and end of the start marker may be tapered to minimize undesired spectral content. The Audio Playout System 11 further inserts, immediately following each avail block, a stop marker consisting, e.g., of a 30-Hz tone of duration 250 msec and level −10 dBFS, as illustrated in FIG. 12. The beginning and end of the stop marker may be tapered to minimize undesired spectral content.

The Audio Playout System 11 further superimposes upon the audio a start marker consisting of a 21-Hz tone of duration 250 msec and level −10 dBFS at the beginning of each avail in an avail block, as illustrated in FIG. 12. The beginning and end of the start marker shall be tapered to minimize undesired spectral content.

The Audio Playout System 11 further provides to the Messaging Center 13 a schedule of upcoming program items via a Raw Data XML file, with the currently playing item at the top of the diagram. An example structure of a Raw Data XML file is shown in FIG. 13. The XML File comprises Avails, an Avail Block Start Marker, and an Avail Block Stop Marker. The Raw Data XML file of FIG. 13 is updated when a new item is added. It lists the current date and time. It may include, e.g., up to twelve items (the current item and at least eleven subsequent items). It includes within its <LENGTH> field a duration in seconds for each item. It includes an item with <GROUP> name START MARKER of duration 250 msec immediately preceding each avail block. It includes within the <COMMENT> field of the Start Marker item the total duration in seconds of the avail block. It includes an item with <GROUP> name STOP MARKER of duration 250 msec immediately following each avail block.

### Messaging Center

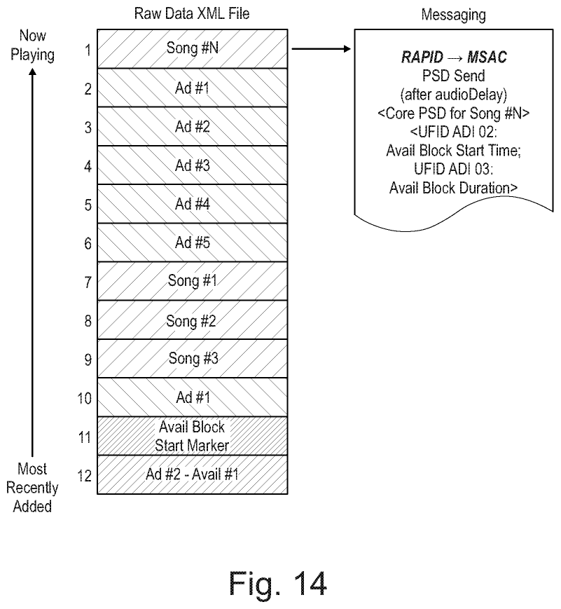

In embodiments, the messaging center 13 (referred to as “Rapid” in the messages of FIGS. 14, 15 and 17-19) polls the Audio Playout System schedule in the Raw Data XML file of FIG. 13 at least once every, e.g., 15 seconds. Upon startup, the messaging center 13 shall send the Ad Insertion Client 14 an XML “AdInsertionCapability-Message” as illustrated in FIG. 11, for each HD Radio audio program (e.g., HD2, HD3, etc.) supporting ad insertion. The message shall include a programId to identify the HD Radio audio program that is carrying avails. The programId may range from 0 to 7, to indicate HD1 through HD8, respectively. The programId may be provided to the messaging center via a configuration file.

The messaging center 13 may further receive, from an XML AdInsertionCapability-Response message, see FIG. 11, an audioDelay introduced by the Ad Insertion Client 14 for a specified audio program.

As shown in FIG. 11, the Ad Insertion Client 14 buffers (delays) the audio received from the Audio Playout System. However, start and stop marker detection is performed on non-buffered audio to allow the receiver sufficient time to process those markers before the associated audio arrives. The messaging center 13 maintains synchronization between its metadata and the buffered audio without disrupting the relative timing between the start/stop markers and the buffered audio. It may delay, over and above the delay normally applied to PSD Send messages, any content sent to the MSAC client for the specified programId by the amount indicated in the audioDelay field of the AdInsertionCapability-Response message described in the preceding paragraph, with the following exception: i) Any UFID fields received in a NotifySampleCounts message from the Ad Insertion Client 14 shall be sent via PSD Send message to the MSAC client 16 immediately upon receipt. ii) These PSD Send messages shall contain the PSD core fields from the preceding schedule item, along with the UFID fields comprising the avail block start sample count, sequence number and start sample count of the individual avails, or the avail block end sample count, respectively. Immediately sending the UFID fields with the core fields of the preceding schedule item ensures timely arrival of the sample counts at the receiver while maintaining core PSD synchronization with the delayed audio.

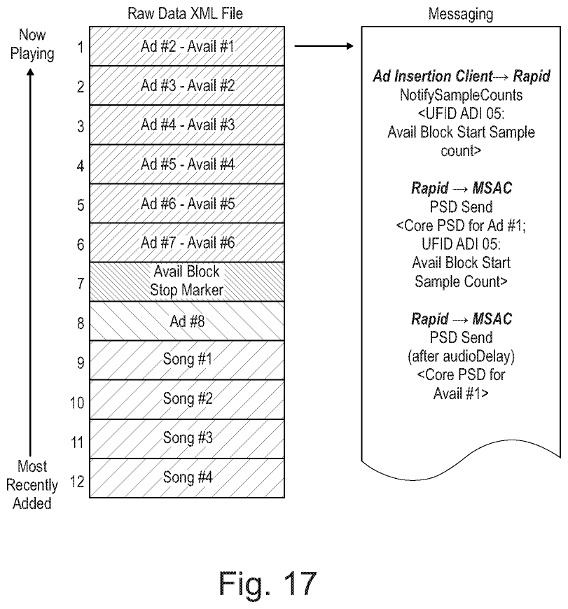

For example, in FIG. 17, a NotifySampleCounts message with a UFID field containing the start sample count of an avail block is received from the Ad Insertion Client 14 during playout of Avail #1. A PSD Send message must then immediately be sent to the MSAC Client 15 containing this UFID field and the core PSD fields for Ad #1 (the preceding schedule item, disregarding the start marker, as shown in FIG. 14). Because of the audio buffering in the Ad Insertion client 14, “Now Playing” Avail #1 from the Audio Playout System shown in FIG. 17 will not yet have been broadcast when this PSD Send message is sent. The core PSD fields for Avail #1 must be sent to the MSAC Client after waiting the requisite audioDelay imposed by the Ad Insertion Client, to ensure proper synchronization with the audio.

At least, e.g., three minutes before broadcast of an avail block, the messaging center 13 may send the MSAC client 15 a PSD Send XML message via TCP to provide advance notification to the receiver that an avail block is scheduled, as illustrated in FIG. 14. This message shall include available core metadata for the current schedule item (after waiting the requisite audioDelay imposed by the Ad Insertion Client), along with two UFID frames comprising the estimated start time and duration in msec, respectively, of the avail block.

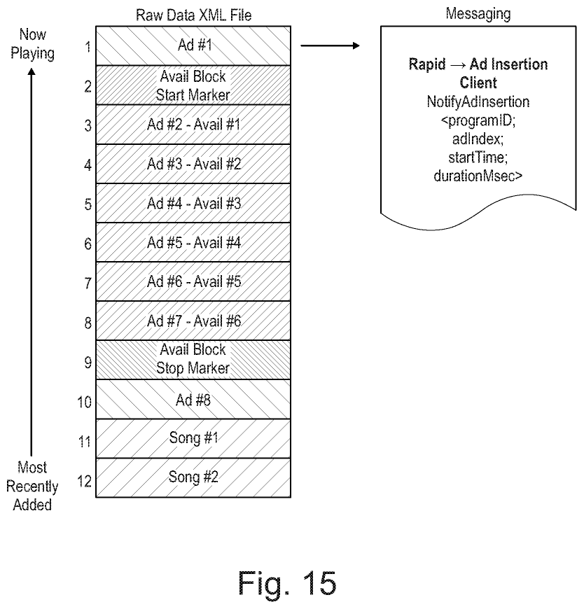

The messaging center 13 may inform the Ad Insertion Client 14 nominally, e.g., ten seconds before broadcast of an avail block start marker, using a NotifyAdInsertion XML message, as illustrated in FIG. 15. The message may include a programId to identify the HD Radio audio program where the avail block resides. The programId shall range from 0 to 7, to indicate HD1 through HD8, respectively. It may include a numeric adIndex that is unique to the avail block. It may further include UTC startTime in hh:mm:ss. fff format at the start of the avail block, exclusive of the start marker, where hh denotes hours from 0 to 23, mm denotes minutes from 0 to 59, and ss.fff denotes seconds from 0 to 59.999, accurate to 1 msec. It may further provide the durationMsec of the avail block, exclusive of the start and stop markers.

Upon playout of the avail block start marker, the messaging center 13 may receive a NotifySampleCounts XML message from the Ad Insertion Client 14 as illustrated in FIG. 17, indicating the start sample count, exclusive of the start marker, of the avail block.

Directly upon receipt from the Ad Insertion Client of the NotifySampleCounts XML message, the messaging center 13 may send the MSAC client a PSD Send XML message via TCP, as shown in FIG. 17. This message may include available PSD core metadata for the preceding schedule item, along with a UFID frame containing the start sample count, exclusive of the start marker, of the avail block. The identifierId UFID field may be formatted in the manner received from the Ad Insertion Client via the NotifySampleCounts XML message. After waiting the requisite audioDelay imposed by the Ad Insertion Client, the messaging center 13 may send the MSAC client 15 a PSD Send XML message via TCP, as shown in FIG. 17. This message may include available PSD core metadata for the current schedule item.

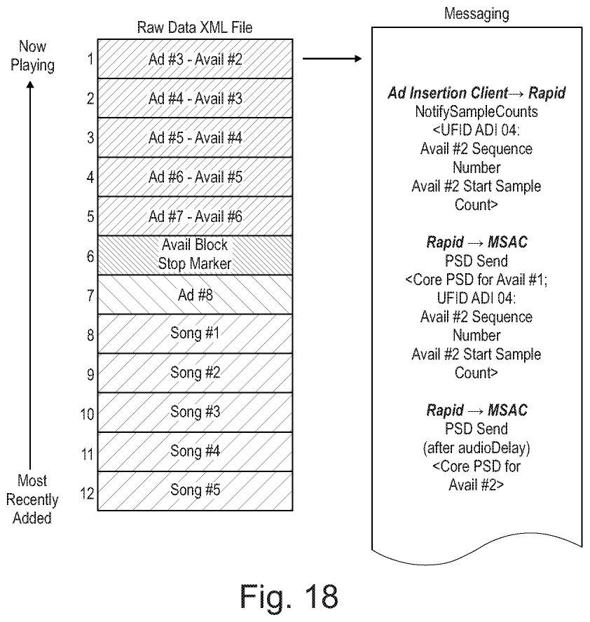

For each individual avail within an avail block, the messaging center 13 may receive a NotifySampleCounts XML message from the Ad Insertion Client 14 as illustrated in FIG. 18, indicating the sequence number and start sample count of that avail. The sequence number uniquely identifies an avail within an avail block and shall be set to 0 for the first avail in the avail block, 1 for the second avail in the avail block, and so on.

Directly upon receipt from the Ad Insertion Client of the NotifySampleCounts XML message the messaging center 13 may send the MSAC client 15 a PSD Send XML message, as shown in FIG. 18. This message may include, for a particular avail within an avail block, available PSD core metadata for the preceding schedule item, along with a UFID frame containing the sequence number and start sample count of that avail. The identifierId UFID field shall be formatted in the manner received from the Ad Insertion Client via the NotifySampleCounts XML message. After waiting the requisite audioDelay imposed by the Ad Insertion Client, the messaging center 13 may send the MSAC client 15 a PSD Send XML message as shown in FIG. 18. This message may include available PSD core metadata for the current schedule item.

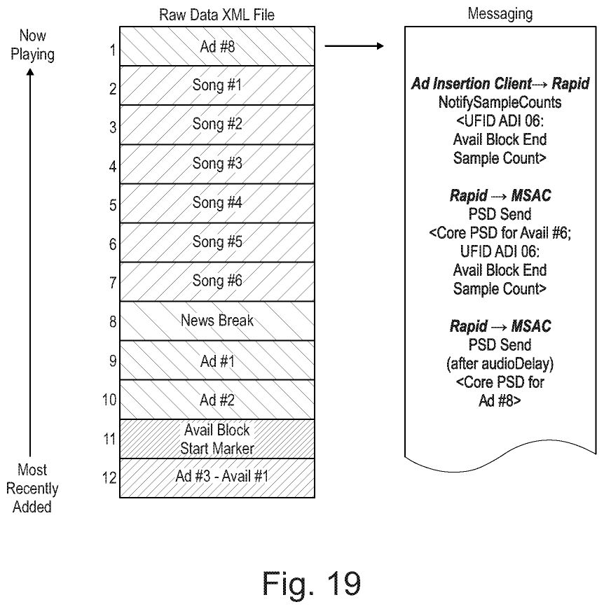

Upon playout of the avail block stop marker, the messaging center 13 may receive a NotifySampleCounts XML message from the Ad Insertion Client, as illustrated in FIG. 19 indicating the end sample count, exclusive of the stop marker, of the avail block.

Directly upon receipt from the Ad Insertion Client of the NotifySampleCounts XML message, the messaging center 13 may send the MSAC client a PSD Send XML message as shown in FIG. 19. This message may include available PSD core metadata for the preceding schedule item, along with a UFID frame containing the end sample count, exclusive of the start marker, of the avail block. The identifierId UFID field shall be formatted in the manner received from the Ad Insertion Client 14 via the NotifySampleCounts XML. After waiting the requisite audioDelay imposed by the Ad Insertion Client 14, the messaging center 13 shall send the MSAC client a PSD Send XML message via TCP, as shown in FIG. 19. This message shall include available PSD core metadata for the current schedule item.

It is to be noted that some radio stations accept a direct live audio feed from a syndicated source, in lieu of an audio playout system. In such cases, schedules must be sent directly from such syndicator to the messaging center 13. Furthermore, ad markers would need to be inserted in the audio stream by the syndicator or at the local radio station.

### Ad Insertion Client

In embodiments, the ad insertion client 14 receives from the Audio Playout System 11 or Audio Processor 12 a full-scale stereo PCM digital audio stream at a sample rate of 44.1 kHz via an AES3 interface. It may apportion the digital audio stream into contiguous payload blocks, each comprised of an integer multiple of watermark blocks of 512 stereo audio samples. It tags each payload block with a 32-bit unsigned integer corresponding to the sample count of the first stereo audio sample of the block. The first payload block shall have a sample count of 0, and the sample count shall increment by the payload block size with each succeeding payload block. Should the sample count reach a maximum value, it shall roll over to 0 and continue counting with each new input payload block. The ad insertion client 14 further applies watermarks to the input digital audio stream. Each 512-sample watermark block shall be capable of accommodating a single watermark (as supported by the audio content) with an 8-bit payload containing a portion of the 32-bit sample count. The ad insertion client 14 shall call the watermarking encoder to insert the watermarks into watermark blocks. The ad insertion client 14 further buffers (delays) the audio, if necessary, for, e.g., not more than ten seconds. The ad insertion client 14 sends the delayed audio to the importer/exporter 16 for HDC encoding and subsequent transmission. Further, the ad insertion client 14 may receive an XML AdInsertionCapability-Message from the messaging center 13.

Upon receipt of an AdInsertionCapability-Message from the messaging center 13, the ad insertion client 14 may sent to the messaging center 13 the audio delay through the Ad Insertion Client using an XML AdInsertionCapability-Response message. The programId in the AdInsertionCapability-Response XML message may be copied from the corresponding AdInsertionCapability-Message. The enable parameter may indicate to the messaging center 13 the status of the Ad Insertion Client (on/off). The audioDelay parameter may be formatted as a 32-bit unsigned integer and shall indicate the delay in msec through the Ad Insertion Client 14.

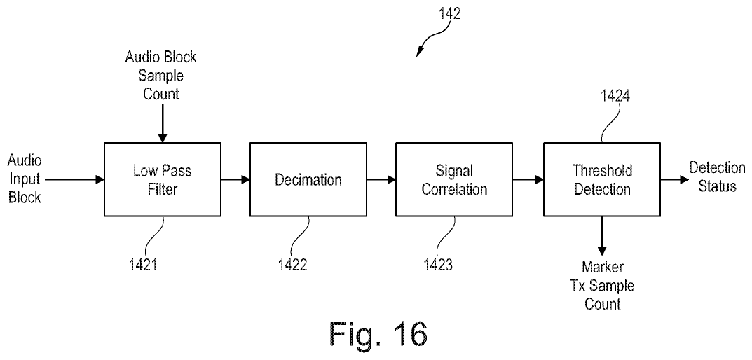

The ad insertion client 14 is further configured to detect ad markers within the input digital audio stream. As discussed, such detection takes place in the ad marker detection unit 142 shown in FIG. 11. FIG. 16 shows an embodiment of such an ad marker detection unit 142. The unit 142 comprises a low-pass filter 1421, a decimation unit 1422, a signal correlation unit 1423 and a threshold detection unit 1424. After low-pass filtering in low-pass filter 1421, the sample rate of the audio stream is reduced in decimation unit 1422 to prepare for determining a signal correlation. In signal correlation unit 1423, a signal correlation between the audio stream and a signal which corresponds to the start marker is determined. For example, a signal correlation between the audio stream and a low-frequency audio signal which corresponds to the start marker signal may be determined. If the signal correlation lies above a threshold which is the determined in unit 1424, the detection status is positive and a sample count corresponding to the marker location is provided to the messaging center 13.

Further, upon receipt of a NotifyAdInsertion XML message from the messaging center 13, as illustrated in FIG. 15, the ad insertion client 14 begins searching the non-buffered, tagged audio blocks for an avail block start marker. Directly upon detection of an avail block start marker, the ad insertion client 14 calculates the start sample count for the avail block. It further estimates a start sample count for the avail block using a local time source and the UTC startTime read from the NotifyAdInsertion XML message received from the messaging center 13. If the calculated start sample count does not agree with the estimated start sample count within 88200 audio samples, the start sample count for that avail block shall be discarded. If the calculated and estimated start sample count values agree within 88200 audio samples, the ad insertion client 14 sends to the messaging center 13 a validated start sample count for the avail block, exclusive of the start marker, via a NotifySampleCounts XML message, as illustrated in FIG. 17.

More particularly, the programId in the NotifySampleCounts XML message shall identify the HD Radio audio program where the avails reside. The programId shall range from 0 to 7, to indicate HD1 through HD8, respectively. The start sample count shall be formatted as a 32-bit unsigned integer. The value ADI;05; shall be assigned to attribute ownerId in the NotifySampleCounts XML message. The avail block start sample count shall be assigned to attribute identifierId in the NotifySampleCounts XML message.

For each individual avail within an avail block, the ad insertion client 14 shall detect an avail start marker. Directly upon detection of an individual avail start marker, the ad insertion client 14 determines the start sample count for that avail and sends to the messaging center 13 its sequence number and start sample count via a NotifySampleCounts XML message, as illustrated in FIG. 18. The sequence number uniquely identifies an avail within an avail block and shall be set to 0 for the first avail in the avail block, 1 for the second avail in the avail block, and so on. The programId in the NotifySampleCounts XML message may identify the HD Radio audio program where the avails reside. The programId may range from 0 to 7, to indicate HD1 through HD8, respectively. The sequence number and start sample count may be formatted together as a 40-bit unsigned integer, where the most significant byte is the avail sequence number, and the following four bytes represent the start sample count of the avail.

The value ADI;04; shall be assigned to attribute ownerId in the NotifySampleCounts XML message. The sequence number and avail start sample count shall be assigned to attribute identifierId in the NotifySampleCounts XML message.

Directly upon detection of an avail block stop marker, the ad insertion client 14 calculates the end sample count of the avail block. It estimates an end sample count for the avail block using a local time source and the UTC startTime and durationMsec of the avail block, as read from the NotifyAdInsertion XML message received from the messaging center 13. If the calculated end sample count does not agree with the estimated end sample count within 88200 audio samples, the end sample count for that avail block shall be discarded. If the calculated and estimated end sample count values agree within 88200 audio samples, the ad insertion client 14 sends to the messaging center a validated end sample count for the avail block, exclusive of the stop marker, via a NotifySampleCounts XML message, as illustrated in FIG. 19. The programId in the NotifySampleCounts XML message shall identify the HD Radio audio program where the avails reside. The programId may range from 0 to 7, to indicate HD1 through HD8, respectively. The end sample count may be formatted as a 32-bit unsigned integer. The value ADI;06; may be assigned to attribute ownerId in the NotifySampleCounts XML message. The avail block end sample count may be assigned to attribute identifierId in the NotifySampleCounts XML message.

### MSAC Client

In embodiments, the MSAC client 15 may receive from the messaging center 13 PSD Send XML messages containing PSD core fields, the UTC start time and duration of an upcoming avail block, a start sample count value for each avail block, the sequence number and start sample count of each constituent avail within an avail block, and an end sample count value for each avail block. The MSAC Client 15 shall then generate ID3 tags with PSD UFID frames and shall forward them to the appropriate PSD port—either an Audio Client (for SPS data) or the Exporter 16 (for MPS data). The MSAC client 14 uses the location attribute in the PSD Send message received from the messaging center 13 to direct the ID3 tag to the proper PSD port.

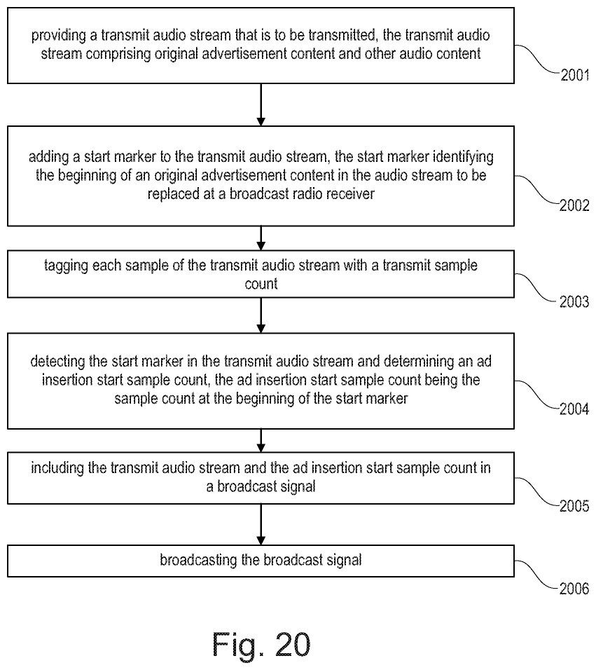

Aspects of the provision of a digital audio broadcast signal explained with respect to FIGS. 11 to 19 are summarized in the flowchart of FIG. 20. In step 2001, a transmit audio stream that is to be transmitted is provided, the transmit audio stream comprising original advertisement content and other audio content. In step 2002, a start marker is added to the transmit audio stream, the start marker identifying the beginning of an original advertisement content in the audio stream to be replaced at a broadcast radio receiver. In step 2003, each sample of the transmit audio stream is tagged with a transmit sample count. In step 2004, the start marker is detected in the transmit audio stream and an ad insertion start sample count is determined, the ad insertion start sample count being the sample count at the beginning of the start marker. In step 2005, the transmit audio stream and the ad insertion start sample count are included in a broadcast signal. In step 2006, the broadcast signal is broadcast as a digital over-the-air radio broadcast signal. Alternatively, in case the broadcast signal is analog, the ad insertion start sample count may be sent over the Internet to a server, from which it is provided to radio receivers.

### III. Physical Transitioning—Radio Receiver

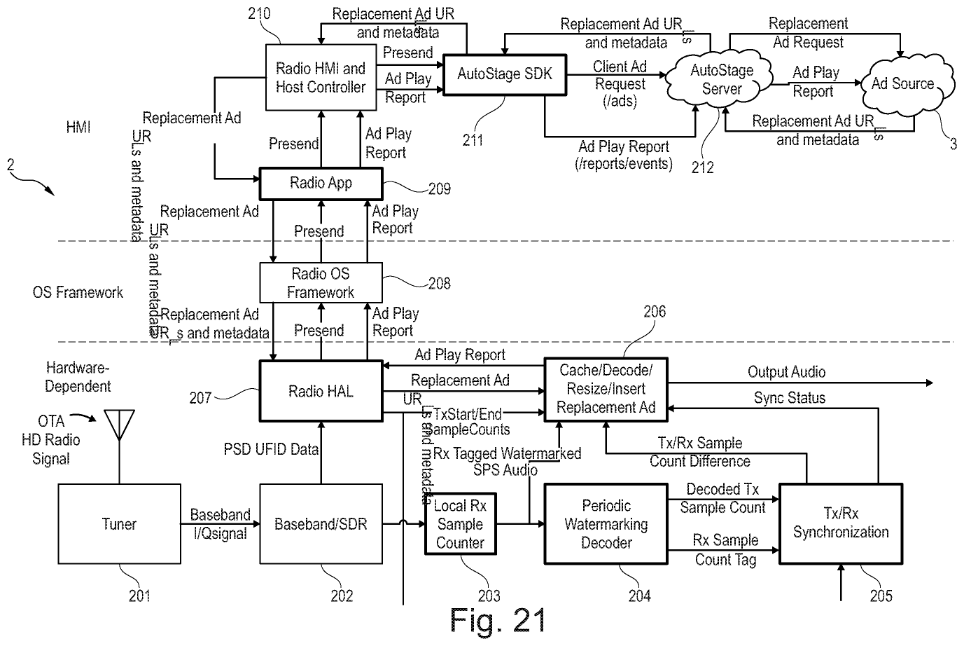

Next, an embodiment of the radio receiver 2 of FIG. 1 is discussed in more detail. FIG. 21 shows an embodiment of a functional block diagram of a receiver 2. The receiver 2 comprises a tuner 201, a baseband unit 202, a local receive sample counter 203, a periodic watermarking decoder 204, a transmit/receive synchronization unit 205, a replacement ad unit 206, a radio HAL 207, a radio OS framework 208, a radio app 209, a radio HMI and host controller 210, an AutoStage SDK 211, an AutoStage Server 212, and an Ad Server 3.

The radio receiver 2 is only discussed with respect to features related to the present invention. Also, it is pointed out that using an AutoStage SDK and an AutoStage Server 212 to receive IP-content from the Ad Server 3 represents an embodiment only, and, alternatively, IP content may be received from the Ad Server directly through a communication module 22 as described with respect to FIG. 1.

The local receive sample counter 203, the periodic watermarking decoder 204, and the transmit/receive synchronization unit 205 serve to synchronize the transmit and receive audio streams as discussed with respect to FIGS. 2 to 10. The actual ad insertion and replacement takes place in replacement ad unit 206, which also provides for caching, decoding, and resizing.

The functions implemented by the receiver 2 allow integration of ad insertion functionality into the radio framework. In particular, it accesses 44.1-kHz dual-channel PCM AES digital audio from the HD Radio baseband processor, delivers 44.1-kHz dual-channel PCM AES digital audio to the receiver audio output, and decodes PSD UFID messages providing advance notification to the receiver that an avail block is scheduled.

These messages are broadcast at least three minutes in advance of the avail block to afford the receiver client sufficient time to request, download (via a potentially compromised cellular channel), decode, and resize a block of replacement advertisements. An NTP timestamp indicating the start time of the avail block shall be extracted from the Identifier field in the UFID frame of the ID3 tag in unsigned 64-bit fixed-point format. The duration in msec of the avail block shall be extracted from the Identifier field in the UFID frame of the ID3 tag as an unsigned 32-bit integer. When advance notification of an avail block is decoded, the receiver client shall request and retrieve, e.g., via the DTS AutoStage API, a block of MP3 replacement advertisements from the Ad Source 3.

The receiver 2 may further send to the Ad Source 3 a request for replacement advertisements via, e.g., an AutoStage endpoint, specifying the broadcastId of the radio station and the approximate duration in msec of the avail block. The receiver 2 may further receive from the Ad Source 3, for each replacement advertisement in the avail block, a URI to access the MP3-encoded audio, along with metadata including, but not limited to, advertiser name and advertisement ID, title, relative location within the avail block, duration in msec, and encoded bitrate in kbps.

The duration of each replacement advertisement should be accurate to within one msec. The Ad Source 3 may not provide expired replacement advertisements to the receiver subsystem. The Ad Source 3 may not provide duplicate replacement advertisements for substitution within the same avail block. The Ad Source 3 may select replacement advertisements to meet exclusivity requirements within an avail block.

The start sample count is extracted from the Identifier field in the UFID frame of the ID3 tags as an unsigned 32-bit integer. Further, the PSD UFID messages providing the sequence number and start sample count of each individual avail within an avail block are decoded. The sequence number uniquely identifies an avail within an avail block and is set to 0 for the first avail in an avail block, 1 for the second avail in an avail block, and so on. The sequence number and start sample count shall be extracted from the Identifier field in the UFID frame of the ID3 tag as an unsigned 40-bit integer, where the most significant byte is the avail sequence number, and the following four bytes represent the start sample count of the avail.

The PSD UFID messages providing the end sample count, exclusive of the stop marker, for each avail block are also decoded. The end sample count shall be extracted from the Identifier field in the UFID frame of the ID3 tags as an unsigned 32-bit integer. Avails within the avail block shall be substituted with a contiguous block of replacement advertisements obtained from an Ad Source.

The duration of the block of replacement advertisements shall be adjusted by the receiver subsystem to align with the duration of the avail block, such that the start and end of the block of replacement advertisements shall align with the start and end of the avail block within 100 msec. The first and last advertisements in a block of replacement advertisements are smoothly transitioned with the adjacent OTA audio programs to ensure a favorable user experience. Audio levels of replacement advertisements shall be aligned with broadcast audio levels using the audio processor in the receiver.

If the start sample count of an avail block is not received in a timely manner (e.g., due to channel impairments), substitution of its constituent avails shall not be performed.

The receiver 2 may substitute as many replacement advertisements within an avail block as possible, subject to availability of replacement advertisements. If sufficient replacement advertisements are not available to fill an entire avail block, the contiguous block of supplied replacement ads shall be positioned at the end of the avail block, and avails at the start of the avail block shall not be replaced. In this case, the receiver subsystem shall insert the supplied replacement advertisements between the start sample count of the first replaced avail and the end sample count of the avail block. If the start sample count of the avail associated with the first replacement advertisement is not received when expected, insertion of that replacement advertisement shall not occur. Insertion of subsequent replacement advertisements shall commence upon receipt of the earliest avail start sample count associated with those replacement advertisements. In this case, the receiver subsystem shall use the avail sequence number to determine the number of required replacement ads. For example, if the avail block supports six replacement ads, and the first received sequence number has a value of three, then at most three avails may be replaced, subject to the availability of replacement ads.

Using the URIs described above, the receiver 2 may download all replacement advertisements that are not currently cached. It may cache each downloaded MP3 replacement advertisement for use in future avail blocks, subject to available memory resources. It may further decode and resize MP3 replacement advertisements as their corresponding avails are being replaced, to minimize required receiver storage.

Resizing parameters may be determined before audio decoding of the replacement ad commences. If resizing requires increasing the original duration of the replacement advertisement by more than 10%, then the extension shall be limited to 10%, with silence applied to the balance of the duration in a manner that ensures a favorable user experience. If resizing requires decreasing the original duration of the replacement advertisement by more than 10%, then ad insertion shall not commence for that avail block. Resizing shall be distributed among all replacement ads within an avail block in proportion to the original size of each replacement ad.

Since a contiguous block of replacement ads is inserted between the start of the first replaced avail and the end of the avail block, the transition between the final replacement ad and the adjacent OTA audio program may require refinement to ensure a favorable user experience.

The receiver 2 derives the Tx audio sample count from the received 44.1-kHz dual-channel PCM AES digital audio stream. It may apportion the received digital audio stream into payload blocks of 44.1-kHz stereo digital audio samples, where each payload block shall be comprised of an integer multiple of 512 stereo audio samples. It may tag each payload block with a local Rx audio sample count corresponding to the lead (oldest) sample in that payload block. The Rx audio sample count shall be 0 for the first payload block. It may deliver the tagged payload blocks to the watermark decoding and ad insertion processes. It may apportion the payload blocks into an integral number of 512-stereo-sample watermark blocks, each tagged with its own lead sample count. It may decode the watermarks within the 512-sample digital audio payload blocks. It may recover a Tx audio sample count from the watermark payload of any payload block with a decodable watermark. It may compute differences between the Tx and Rx audio sample counts by synchronizing the Tx audio sample counts from the watermark payloads with the local Rx audio sample count tags to within the accuracy defined above. It may resolve synchronization window ambiguity by applying the Tx start sample count to the Tx/Rx sample count difference computed. It may derive the Tx audio sample count by applying the Tx/Rx audio sample count difference to the local Rx audio sample count. It may set a synchronization flag when synchronization has been established. Within several minutes of retrieving a replacement ad, it may report to the Ad Source, via a DTS AutoStage endpoint, when a replacement advertisement is successfully played at the receiver audio output.

### IV. Ad Insertion Resizing and Transition design

This chapter focuses on example aspects of the transitioning between playing an original ad and a replacement ad or between playing a replacement ad and playing the original audio content again. The OTA radio signal, transmitted by the broadcaster, will contain Stop sets (Ad blocks) that consists of several ads (see FIG. 12). Some or maybe all the ads will be part of an Avail block. An avail block is a group of contiguous ads within a stop set that have been marked as “replaceable.” The avail block is delimited by start/stop markers consisting of, e.g., 0.25 second inaudible tones placed just before and just after the Avail block. Each ad within the avail block contains ad content and a superimposed start marker placed at the beginning of the ad. These marker locations will be detected by the broadcast equipment and sent ahead of the OTA content to the receiver via a data transport. The receiver will use these marker sample counts to know when replacement ads should be inserted.

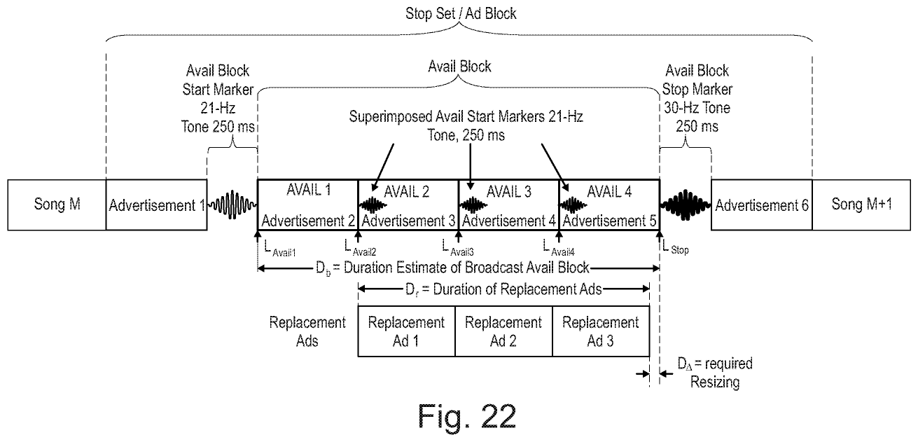

Generally, ad replacement cannot start until three conditions are met: First, sample count synchronization needs to be established between the transmit and receive audio streams. This is addressed by the method and system discussed with respect to FIGS. 2 to 10. The specification for this synchronization is ±100 msec. Second, all replacement ads need to be present in the receiver. This can take on two aspects: all avails have a replacement, or a contiguous subset of avails has replacements. The broadcast system will transmit a start time along with an estimate of the Avail Block duration in milliseconds to the receiver several minutes in advance, allowing the receiver enough time to collect the chosen replacement ads. There is a case when only a subset of replacement ads is available. Third, the Avail Block start marker sample count (see Lₐᵥₐᵢₗ₁ in FIG. 12) must be received in the receiver through the chosen data transport of the system. In the case of having a subset of replacement ads as seen in FIG. 22, receipt of the start sample count of the first Avail being replaced (Lₐᵥₐᵢₗ₂ in this example) is required. Also, with a subset of Replacement ads, the replaced Avails will be those farthest from the Avail Block start marker.

To replace OTA Avails with replacement ads, the system needs to know the duration of each Avail within the avail block. It also needs to know the duration of all the replacement ads. These durations can be subject to two types of errors: the error in the accuracy of the stated Avail/replacement ad durations and the error associated with each ad's ability to accurately match its nominal time slot duration. To compensate for these errors, the overall accumulated error (D_{Δ}) is calculated as shown in equation 11.

D_{Δ}=D_{b}−(L_{AvailN}−L_{Avail1})−Dᵣ (11)

### Where:

D_{b} is the estimate of the Avail Block duration obtained via data channel from Tx broadcast;
Dᵣ is an accurate duration of replacement ads obtained from the ad source;
L_{Avail1} is exact location of the start of Avail 1; L_{AvailN} is exact location of the start of Avail N being replaced;

An example of this calculation is indicated in FIG. 22 which shows an example of having a subset of ad replacements with a resizing error D_{Δ}.

The total error D_{Δ} is distributed proportionately to each of the available replacement ads by calculating the percentage of resizing needed and then multiplying the replacement Ad length by this percentage using equation 12:

D_{resizeadn}=D_{adN}*(D_{Δ}/Dᵣ) (12)

where:
D_{adN} is the original duration of replacement ad N;
Dᵣ is the overall duration of all replacement ads;
D_{Δ} is the calculated duration error;

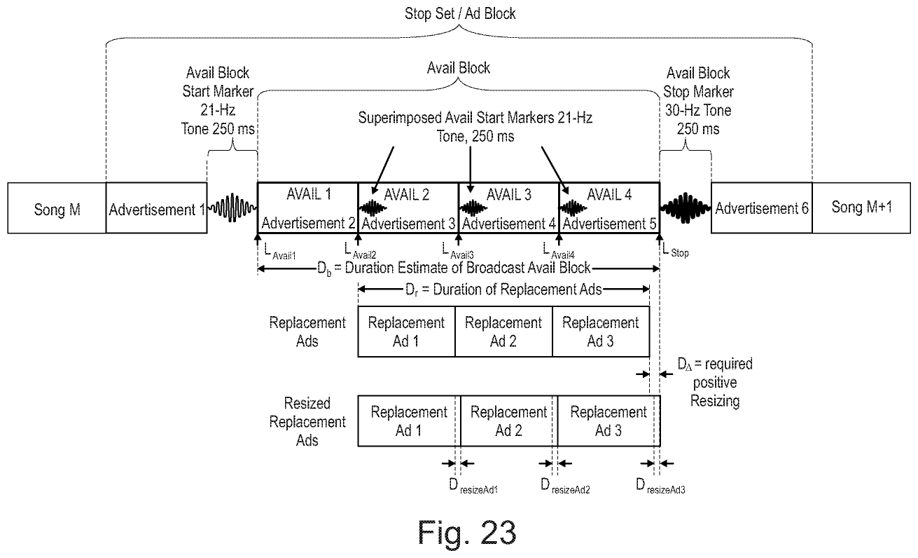

Positive Resizing may be implemented. FIG. 23 is an example that illustrates the case where a subset of avails will be replaced while also calculating a positive DΔ. Each replacement ad is resized by its apportioned amount of error D_{resizeAdN}. In the example, replacement ad 1 will be lengthened by the amount D_{resizeAd1}. Likewise, replacement ads 2 and 3 will be lengthened by the amount D_{resizeAd2} and D_{resizeAd3} respectively.

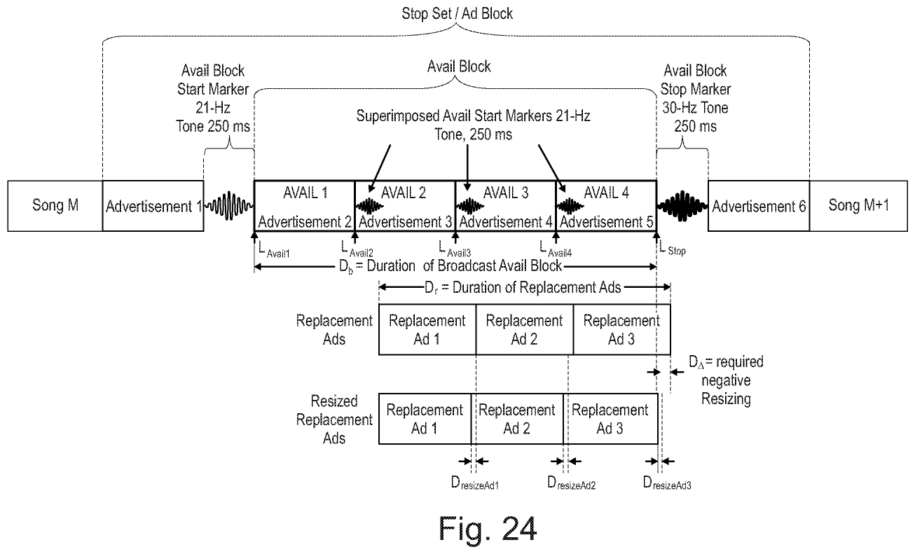

In other embodiments, negative Resizing may be implemented. FIG. 24 illustrates the case where a subset of avails will be replaced while also calculating a negative D_{Δ}. Each replacement ad is resized by its apportioned amount of error D_{resizeAdN}. In this case, replacement ad 1 will be shortened by the amount D_{resizeAd1}. Likewise, replacement ads 2 and 3 will be shortened by the amount D_{resizeAd2} and D_{resizeAd3}, respectively.

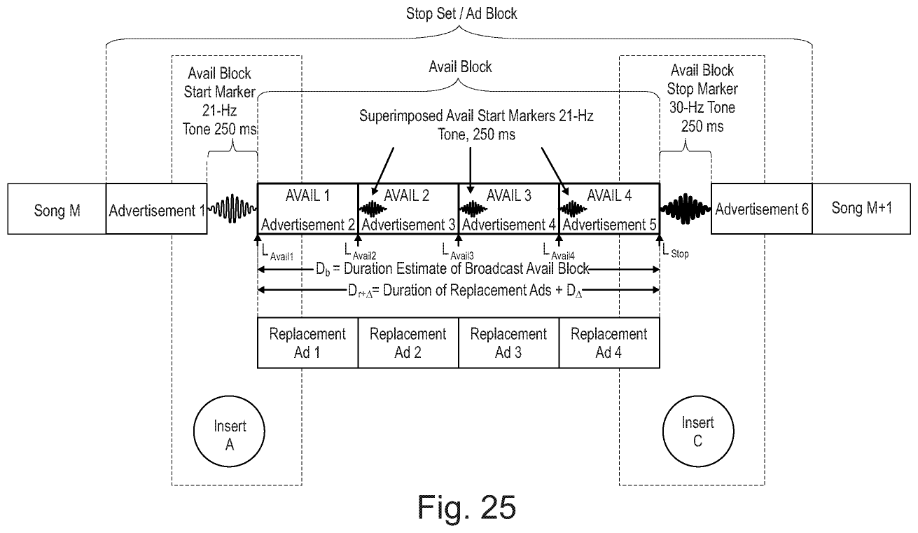

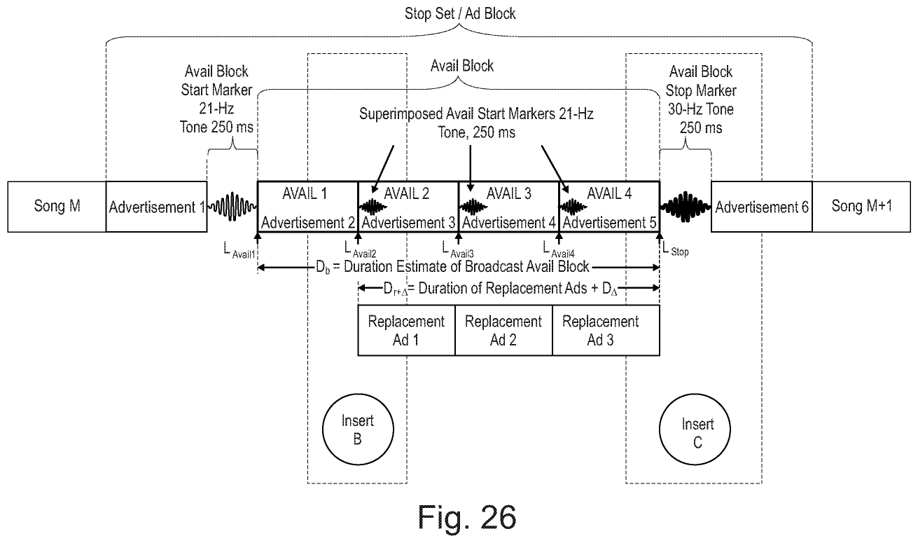

Next, transitioning Between Avails and Replacements Ads is considered. With resizing incorporated within the replacement ads, the design now turns to methods of transitioning between different audio content. It is proposed to observe the regions where the audio stream will be transitioning between the OTA audio and the replacement ads. This may occur in both directions, from OTA audio to replacement ads and from replacement ads to OTA audio. FIGS. 25 and 26 illustrate the cases where all Avails will be replaced and where only a subset of Avails will be replaced. Also, any residual error that is present after Tx/Rx sample count synchronization will be presented using the worst-case synchronization specification of ±100 msec.

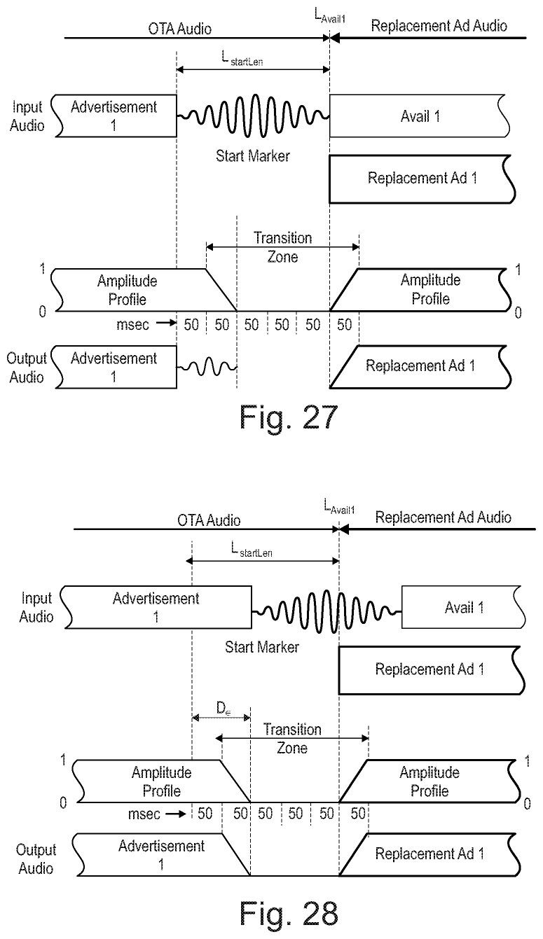

A transition from an Avail Block Start Marker to a Replacement Ad may occur, in accordance with Insert A identified in FIG. 25. Insert A represents the case where all Avails in the Avail Block will be replaced by replacement ads (FIG. 25). The receiver will obtain L_{Avail1}, the Tx sample count at the expected start of Avail 1, from the transmitter. The receiver output audio stream will be switched from OTA to replacement ad at this point. This will allow a transition zone of 250 msec to be established. The transition zone is characterized by an amplitude profile that will be impressed upon the output audio stream as shown in FIG. 27. The transition zone consists of a 50 msec amplitude decrease from 1 to 0 followed by a 150 msec duration where the amplitude is 0, and then a 50 msec amplitude increase from 0 to 1. In this case, a portion of the start marker will be played, but it will be inaudible. Also, no part of Avail 1 should ever be output to the listener. FIG. 27 assumes that there is no synchronization error (D_{ε}). However, there is a 50 msec ramp up of the replacement ad. The Transition at the Beginning of an Avail block with no Synchronization Error (D_{ε}=0 msec) is shown in FIG. 27.

A transition from an Avail Block Start Marker to a Replacement Ad (Insert A) with a Synch Error of 100 msec may take place. FIG. 28 shows the transition at the beginning of an Avail block with worst cast positive Synchronization Error (D_{ε}=100 msec). FIG. 28 looks just like FIG. 27, except the OTA audio stream has been shifted by 100 msec. Again, Avail1 will not be heard by the listener.

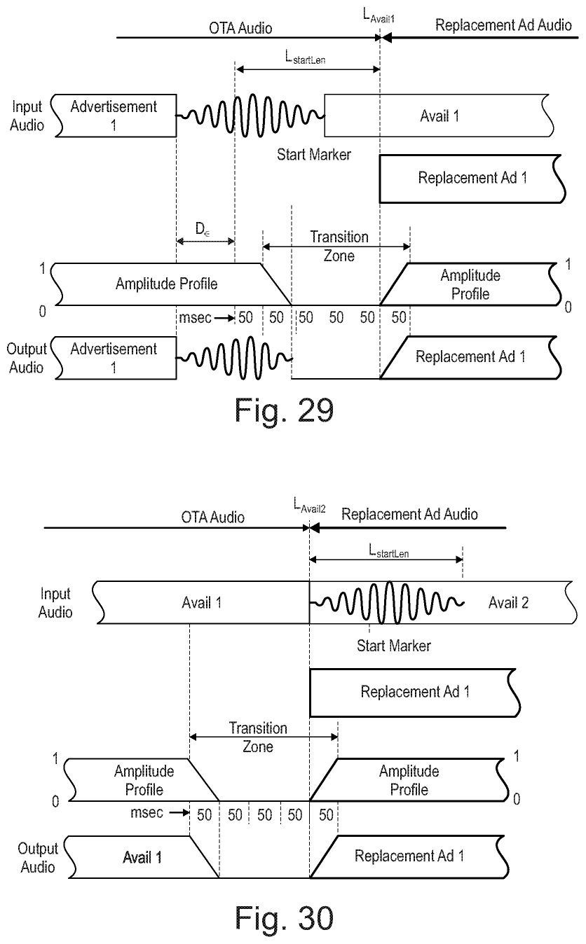

A transition from an Avail Block Start Marker to a Replacement Ad (Insert A) with Synch Error of −100 msec may also occur. FIG. 29 shows the transition at the beginning of an Avail block with worst cast negative Synchronization Error (D_{ε}=−100 msec). FIG. 29 looks like FIG. 27, except the OTA audio stream has been shifted by −100 msec. Again, Avail1 will not be heard by the listener.

A transition from an individual Avail Start Marker to a Replacement Ad (Insert B) may also occur. Insert B represents the case where a subset of Avails in the Avail Block will be replaced by replacement ads (FIG. 26). The receiver will obtain, from the transmitter, L_{Avail2}, the Tx sample count at the expected start of Avail 2. The audio stream will be switched from OTA to replacement ad at this point. This will allow a transition zone of 250 msec to be established. The transition zone contains an amplitude profile. In this setup, the end of Avail 1 will be judiciously attenuated so as not to be heard by the listener. Also, no part of Avail 2 should ever be output to the listener. FIG. 30 shows the transition at the beginning of Avail 2 and assumes that there is no synchronization error (D_{ε}). However, there is a 50 msec ramp up of the replacement ad.

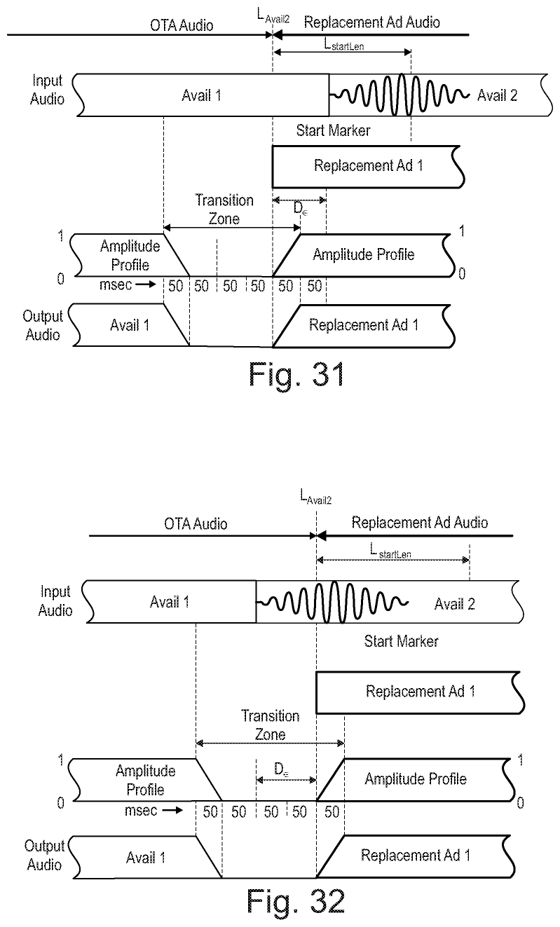

A transition from an Avail Start Marker to a Replacement Ad (Insert B) with a Synch Error of 100 msec may occur. FIG. 31 shows the transition at the beginning of an Avail with worst-case positive Synchronization Error (D_{ε}=100 msec). FIG. 31 looks like FIG. 30 except the OTA audio stream has been shifted by 100 msec. Here, the end of Avail 1 is attenuated for 0.3 sec. Again, Avail 2 will not be heard by the listener.

A transition from the Avail Start Marker to the Replacement Ad (Insert B) with a Synch Error of −100 msec may take place. FIG. 32 shows the transition at the beginning of an Avail with worst-case negative Synchronization Error (D_{ε}=−100 msec). FIG. 32 looks like FIG. 30 except the OTA audio stream has been shifted by −100 msec. Here, the end of Avail 1 is attenuated for 0.1 sec and the start of Avail 2 for 0.1 sec. Again, Avail 2 will not be heard by the listener.

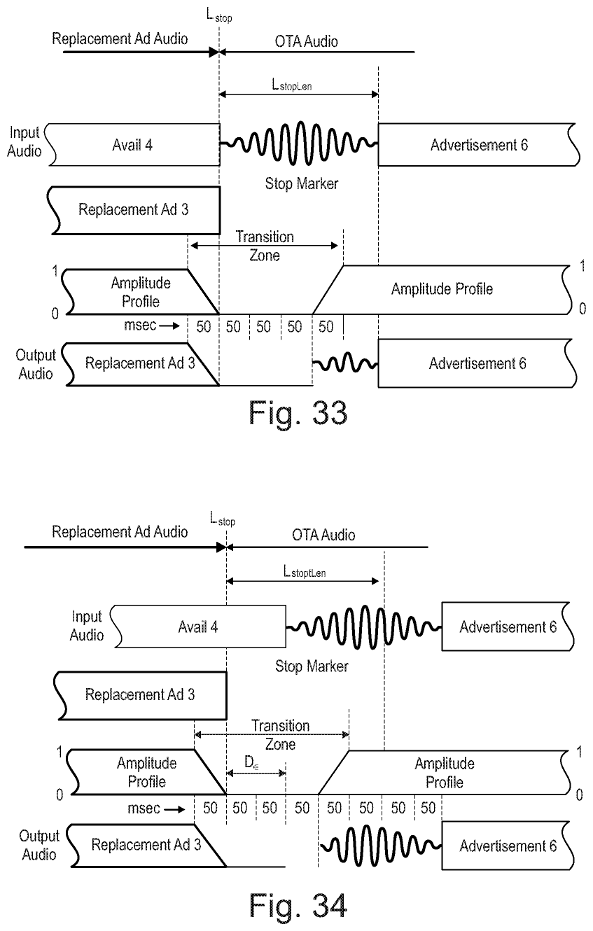

A Transition from a Replacement Ad to the Start of an Avail Block Stop Marker (Insert C) may occur. Insert C represents the case where the Avail block ends (FIG. 25 and FIG. 26). The receiver will obtain, from the transmitter, L_{Stop}, the Tx sample count at the expected start of the Avail Block stop marker. The audio stream will be switched from replacement ad to OTA audio at this point. This will allow a transition zone of 250 msec to be established. The transition zone will contain an amplitude profile that looks just like the amplitude profile described above. In this setup, the end of the last replacement ad will be judiciously attenuated so as not to be heard by the listener. Also, no part of the last Avail should ever be output to the listener. FIG. 33 shows the transition at the end of an Avail Block with no Synchronization Error (D_{ε}=0 msec). There is a 100 msec clip of stop marker audio played but it is at a frequency that should be inaudible.

A Transition from a Replacement Ad to the Start of the Avail Block Stop Marker (Insert C) with a Synch error of 100 msec may take place. FIG. 34 shows the transition at the end of an Avail Block with Worst-Case Positive Synchronization Error (D_{ε}=100 msec). FIG. 34 looks just like FIG. 33 except the OTA audio stream has been shifted by 100 msec. There is a 200 msec clip of stop marker audio played but no part of the last Avail 4 is output to the listener.

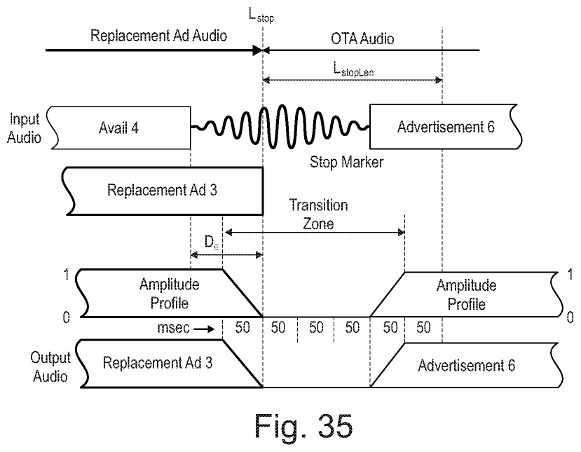

A Transition from a Replacement Ad to the Start of Avail Block Stop Marker (Insert C) with a Synch error of −100 msec may take place. FIG. 35 shows the transition at the end of an Avail Block with Worst-Case Negative Synchronization Error (D_{ε}=−100 msec). FIG. 35 looks just like FIG. 33 except the OTA audio stream has been shifted by −100 msec. There is a 50 msec duration ramp up of the OTA content but no part of the last Avail 4 is output to the listener.

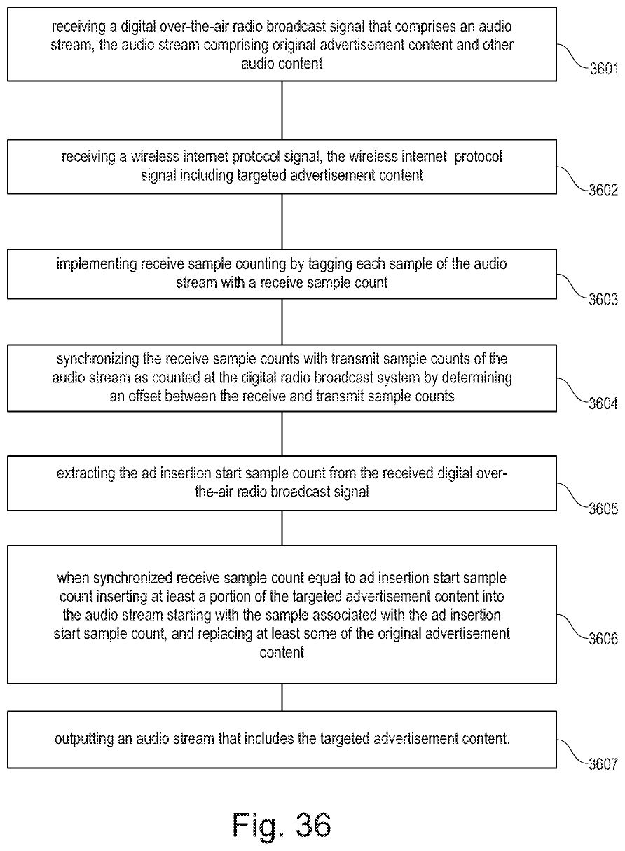

FIG. 36 summarizes the method for processing a digital audio broadcast signal in a broadcast radio receiver such as broadcast receiver 1. In step 3601, a digital over-the-air radio broadcast signal is received, such as from the broadcasting system of FIG. 11. The received digital over-the-air radio broadcast signal comprises an audio stream, the audio stream comprising original advertisement content and other audio content. Also, the received digital over-the-air radio broadcast signal further comprises an ad insertion start sample count which identifies in the audio stream a first sample of an original advertisement content. In step 3602, a wireless internet protocol signal is received, the wireless internet protocol signal including targeted advertisement content. In step 3603, receive sample counting is implemented by tagging each sample of the audio stream with a receive sample count. In step 3604, the receive sample counts is synchronized with transmit sample counts of the audio stream as counted at the digital radio broadcast system by determining an offset between the receive and transmit sample counts. In step 3605, the ad insertion start sample count is extracted from the received digital over-the-air radio broadcast signal. In step 3606, when the synchronized receive sample count is equal to the ad insertion start sample count, at least a portion of the targeted advertisement content is inserted into the audio stream starting with the sample associated with the ad insertion start sample count, and at least some of the original advertisement content is replaced by the targeted advertisement content. In step 3607, an audio stream that includes the targeted advertisement content is outputted.

In the detailed description, the present invention has been described primarily with respect to digital broadcasting. However, it is pointed out that the principles of the invention apply in a similar manner to an analog broadcasting. In such case, the analog audio is sampled both at the transmitter and at the receiver, such that the start and stop sample counts can be determined in the same manner as described. The only change lies in that the start and stop sample counts are sent to the receiver over IP communication or inband-transmission such as RDS.

### Alternate Embodiments and Exemplary Operating Environment

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the system and method described herein, or portions thereof, may be stored, received, transmitted, or read from any desired combination of computer or machine readable media or storage devices and communication media in the form of computer executable instructions or other data structures.

Embodiments of the system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1.-15. (canceled)

16. A method for providing an audio broadcast signal in a radio broadcasting system, the method comprising:
providing a transmit audio stream that is to be transmitted, the transmit audio stream comprising original advertisement content and other audio content;
adding a start marker to the transmit audio stream, the start marker identifying initial content of the original advertisement content in the audio stream to be replaced at a broadcast radio receiver;
tagging each sample of the transmit audio stream with a transmit sample count;
detecting the start marker in the transmit audio stream and determining an ad insertion start sample count, the ad insertion start sample count being the sample count associated with the start marker; and
broadcasting the ad insertion start sample count with the transmit audio stream or sending the ad insertion start sample count to a server over a wide area network.

17. The method of claim 16, wherein determining the ad insertion start sample count comprises:
determining a signal correlation between the transmit audio stream which comprises the start marker and a signal which corresponds to the start marker, wherein, if the signal correlation is above a predetermined threshold, the transmit sample count associated with a location of the start marker is defined to be the ad insertion start sample count.

18. The method of claim 17, wherein the start marker is a non-audible low frequency audio signal, and wherein the signal correlation comprises correlating the transmitted audio stream with the non-audible low-frequency audio signal.

19. The method of claim 16, further comprising:
adding a stop marker to the transmit audio stream, the stop marker identifying end of the original advertisement content in the audio stream to be replaced at the broadcast radio receiver;
detecting the stop marker and determining an ad insertion stop sample count, wherein the ad insertion stop sample count is a sample count associated with the stop marker; and
broadcasting or sending over the wide area network the ad insertion stop sample count.

20. (canceled)

21. The method of claim 16, wherein before determining the ad insertion start sample count a trigger is received from a messaging center indicating start of the original advertisement content in the audio broadcast signal, wherein determining the ad insertion start sample count is started after having received the trigger.

22. The method of claim 21, wherein the trigger is received several seconds before the start of an original advertisement content to be replaced at the broadcast radio receiver, wherein the trigger includes a start time of an advertisement block and a program ID identifying the transmit audio stream carrying the original advertisement content.

23. The method of claim 16, further comprising including in the over-the-air radio broadcast signal an advance notification in advance of scheduling of the original advertisement content.

24. The method of claim 19, wherein the start and stop markers are at least one of silence, an audible chirp, or an inaudible tone.

25. (canceled)

26. The method of claim 16, further comprising embedding watermarks periodically into the transmit audio stream after tagging each sample of the transmit audio stream with a transmit sample count.

27.-49. (canceled)

50. A radio broadcast system comprising:
an audio playout system to:
provide a transmit audio stream that is to be transmitted, the transmit audio stream comprising original advertisement content and other audio content; and
add a start marker to the transmit audio stream, the start marker identifying initial content of the original advertisement content in the audio stream to be replaced at a broadcast radio receiver; and
an ad insertion client to:
tag each sample of the transmit audio stream with a transmit sample count;
detect the start marker in the transmit audio stream and determine an ad insertion start sample count, the ad insertion start sample count being the sample count associated with the start marker; and
a radio transmission system configured to broadcast the ad insertion start sample count with the transmit audio stream or send the ad insertion start sample count to a server over a wide area network.

51. The system of claim 50, wherein the ad insertion client determines the ad insertion start sample by:
determining a signal correlation between the transmit audio stream which comprises the start marker and a signal which corresponds to the start marker, wherein, if the signal correlation is above a predetermined threshold, the transmit sample count associated with the start marker location is defined to be the ad insertion start sample count.

52. The system of claim 51, wherein the start marker is a non-audible low frequency audio signal, and wherein the signal correlation comprises correlating the transmitted audio stream with the non-audible low-frequency audio signal.

53. The system of claim 50, wherein
the audio playout system adds a stop marker to the transmit audio stream, the stop marker identifying end of the original advertisement content in the audio stream;
the ad insertion client detects the stop marker and determine an ad insertion stop sample count, wherein the ad insertion stop sample count is a sample count associated with the stop marker; and
the radio transmission system broadcasts or sends over the wide area network the ad insertion stop sample count.

54. (canceled)

55. The system of claim 50, wherein the ad insertion client receives a trigger from a messaging center of the system, wherein the trigger is received before determining the ad insertion start sample count, wherein the trigger indicates start of the original advertisement content in the audio signal, and wherein the ad insertion client is configured to start determining the ad insertion start sample count after having received the trigger.

56. The system of claim 55, wherein the ad insertion client receives a trigger several seconds before the start of an original advertisement content that is to be replaced at the broadcast radio receiver, wherein the trigger includes a start time of an advertisement block and a program ID identifying the transmit audio stream carrying the original advertisement content.

57. The system of claim 50, wherein the system includes in a radio broadcast signal an advance notification in advance of broadcast of the original advertisement content that is to be replaced at the broadcast radio receiver.

58. The system of claim 50, wherein the ad insertion client tags each sample of the transmit audio stream with a transmit sample count by tagging each sample of the transmit audio stream with an N-bit unsigned integer sample count which increments by one with each input sample, wherein, if the sample count reaches a maximum value, it starts counting again.

59. The system of claim 50, wherein the marker is at least one of silence, an audible chirp, and an inaudible tone.

60. (canceled)

61. The system of claim 50, wherein the ad insertion client embeds watermarks periodically into the transmit audio stream after tagging each sample of the transmit audio stream with a transmit sample count.

62.-72. (canceled)

73. A computer program product embodied on a non-transitory computer readable medium comprising instructions stored thereon to cause one or more processors to:
generate a transmit audio stream that is to be transmitted, the transmit audio stream comprising original advertisement content and other audio content;
add a start marker to the transmit audio stream, the start marker identifying beginning of an original advertisement content in the audio stream to be replaced at a broadcast radio receiver;
tag each sample of the transmit audio stream with a transmit sample count;
detect the start marker in the transmit audio stream and determining an ad insertion start sample count, the ad insertion start sample count being the sample count at the beginning of the start marker;
broadcast the ad insertion start sample count with the transmit audio stream or sending the ad insertion start sample count to a server over a wide area network.

74. (canceled)
